(19) United States
(12) Patent Application Publication
(10) Pub. No.: US 2024/0409703 A1
(43) Pub. Date: Dec. 12, 2024

(54) DIAZIRINE-BASED EPOXY PRIMERS FOR THE PREPARATION OF POLYMER COMPOSITE MATERIALS AND POLYMERIC DIAZIRINES FOR ADHESION OF PLASTICS AND RELATED MATERIALS

(71) Applicant: XLYNX MATERIALS INC., Sidney (CA)

(72) Inventors: Jeremy E. WULFF, Victoria (CA); Rashid NAZIR, Victoria (CA); Liting BI, Victoria (CA); Stefania MUSOLINO, Victoria (CA)

(73) Assignee: XLYNX MATERIALS INC., Sidney, BC (CA)

(21) Appl. No.: 18/700,211

(22) PCT Filed: Oct. 12, 2022
(86) PCT No.: PCT/CA2022/051500

§ 371 Date: Apr. 10, 2024

Related U.S. Application Data
(60) Provisional application No. 63/254,669, filed on Oct. 12, 2021.
(60) Provisional application No. 63/297,432, filed on Jan. 7, 2022.

(51) Int. Cl. C08J 7/043; C08J 7/18

(52) U.S. Cl. CPC C08J 7/043; C08J 7/18; C08J 2323/06; C08J 2363/00; C08J 2379/04

(57) ABSTRACT

Diazirine-containing polymers (also referred to as polymeric diazirines or polydiazirines) are useful in the adhesion of a broad range of substrates, including low-surface energy polymers such as polyethylene. In addition to being employed as single-component adhesives, such agents can be used as surface-activating primers, which can enable traditional adhesive reagents to bond previously challenging substrates. The presence of the diazirine group within or along the polymer chain allows the reagents to covalently bond directly to substrate surfaces via C—H, O—H, or N—H insertion, while also leading to crosslinking and aggregation within the polymeric reagent itself.

### FIELD OF THE INVENTION

Reinforced polymer composites and adhesion of non-biological materials

### BACKGROUND OF THE INVENTION

The aerospace and automotive industries increasingly rely upon light-weight, high-strength fibre reinforced polymer composites for manufacturing. In most cases, the polymer matrix for these composite materials is some form of epoxy resin, while the fibre reinforcing agent is either fibreglass or carbon fibre. However, while fibreglass-epoxy and carbon fibre-epoxy composites have many desirable properties that have encouraged their widespread use (e.g. high stiffness and excellent compressive strength) there remain important limitations. For example, both glass and carbon fibres suffer from undesirable brittleness, and both types of strengthening fibres have an undesirably high density. There is therefore considerable interest in developing epoxy composites that can make use of alternative fibre reinforcing agents.

Commercial two-component epoxy/hardener systems consist of a linear telechelic polymer that terminates in epoxide groups (i.e. ‘epoxy resin’) and a hardener that incorporates multiple nucleophilic groups-usually amines or thiols. When mixed together, the nucleophilic residues within the hardener can add to the electrophilic epoxide groups in the epoxy resin. This results in the formation of multiple crosslinks throughout the material (FIG. 1), transforming the liquid resin (a thermoplastic) into a hard, non-meltable solid (a thermoset).

Ultra-high molecular weight polyethylene (UHMWPE) fibre is a good candidate as a fibre reinforcing agent, since it has a high ultimate tensile strength (2.9 GPa) together with a low density (0.97 g/mol). Unfortunately, there is a mismatch between the very lipophilic (i.e. low surface energy; ca. 28-35 mJ/m²) UHMWPE fibre and the polar (i.e. high surface energy) epoxy matrix. As a result, it remains difficult to prepare good-quality UMHWPE-epoxy composites without relying on destructive and expensive surface treatments (e.g. corona discharge) to oxidize the polyethylene surface and make it more receptive to binding with the epoxy matrix. While such methods do afford increased adhesion between the polyethylene fibre and the matrix, they can result in chain-fragmentation and other undesirable processes that compromise the integrity of the fibre.

It has been shown that diazirine-based reagents can be useful for crosslinking and/or functionalizing low-functionality commodity polymers, including polyethylene (see FIG. 2). The diazirine group can be activated thermally (by treatment with temperatures above 80° C.) or photochemically (by excitation with 350-365 nm light), or else through the application of an electric potential (−1.6 V vs. Ag/AgCl) or through the use of a photosensitizer. In all cases, high-energy carbenes are produced, which engage in promiscuous C—H insertion reactions along the aliphatic backbone of the polymer.

Adhesive bonding to low surface energy substrates (e.g. polymers such as polyethylene, polypropylene and the like) remains a challenge in applications ranging from automotive assembly to the manufacture of medical devices and personalized electronics. Traditional single-component adhesives are either polymer-based materials (e.g. polyurethanes or silicones) or are small-molecule monomers that polymerize on contact with air (e.g. cyanoacrylates) to form the adhesive polymer layer. Two-component adhesives include epoxy-based systems where an oligoamine hardener reagent is used to introduce crosslinks to an epoxide-containing prepolymer. Whether one- or two-component systems are used, the final result is a polymeric adhesive layer (often crosslinked) that does not make any covalent bonds with the surface of the polymer that is being glued. Adhesion thus results from a combination of hydrogen bonds (for high-polarity surfaces like wood or paper), dipolar interactions (for highly polar surfaces, as well as surfaces of more moderate polarity like polyesters or polyamides), Van der Waals forces, and physical entanglements between polymer chains. Because low surface energy materials lack organic functional groups such as alcohols, amines, or carbonyl groups, they cannot engage with the adhesive layer through hydrogen bonding interactions or dipolar interactions. As a result, low surface energy polyolefins tend to suffer from facile adhesion failure with typical adhesives. This is particularly true for polymers with a high degree of crystallinity (e.g. ultra-high molecular weight polyethylene) since the tightly packed crystalline domains of the substrate polymer do not permit interpenetration of the adhesive polymer.

It is known in the art that diazirine groups can be used as convenient precursors of high-energy carbenes, which can insert into the C—H bonds of aliphatic polymers like polyethylene and polypropylene (FIG. 12). Activation, which occurs with loss of nitrogen gas, can be accomplished thermally (e.g. by heating at temperatures >110° C.), photochemically (e.g. by irradiating with light at 350-365 nm), or through application of electrical potential or via energy transfer from an activated photosensitizer species. When small-molecule bis-diazirines are sandwiched between two pieces of high density polyethylene prior to thermal activation to unveil the reactive carbene moieties, adhesion strengths of up to 5 MPa are achievable [Science 2019, 366, 875-878 and Chemical Science 2021, 12, 4147-4153]. While they can provide very high levels of adhesion, however, bonds formed from small-molecule adhesives of this type may lack the mechanical toughness that is associated with traditional polymeric adhesives, which can bend and flex in response to mechanical deformation. Moreover, in order for small molecules to form new bonds (crosslinks) between two materials, the surfaces must be closer to one another than the length of the molecule. This requirement means that the two surfaces must typically be flat, and be relatively free of defects.

An alternative strategy, disclosed herein, relates to the use of polymeric diazirines. Like small molecule mono- or bis-diazirines, polymeric diazirines (once suitably activated by the methods described above) may engage in chemical reactions with both functionalized and unfunctionalized polymer surfaces, resulting in strong adhesive bonds even for substrate materials that lack organic functional groups. At the same time, like traditional polymeric adhesives, polymeric diazirines may provide desirable mechanical toughness within the adhesive layer, and may be useful in contexts where irregularly shaped objects need to be bonded.

As an added benefit, polymeric diazirines may engage in reactions with themselves upon activation (FIG. 13), since carbenes that are generated at any point along the polymer chain (including within polymer sidechains) may react through C—H, O—H or N—H insertion at other positions along the polymer chain (or at any point on a polymer sidechain). Additionally, two carbene moieties may dimerize to form an alkene, or one carbene moiety may react with one diazirine moiety to form a diazo linkage (i.e. a substituted hydrazone). Other reaction outcomes are also possible. The result of any these reactions of the polymeric diazirine with itself (in an intramolecular context, an intermolecular context, or both) is the formation of a crosslinked network throughout the adhesive polymer, which will further strengthen any interpenetrating polymer interactions with the substrate surface.

Thus, the diazirine moiety within the polymer serves two distinct functions:
(1) to make strong covalent linkages to the surface of the substrate polymer; and
(2) to make strong bonds within the adhesive layer, which provide additional adhesion strength and additional mechanical strength.

It will be understood by those of ordinary skill in the art that either of function (1) or function (2), or the combination of the two functions, will be useful in bonding both similar and dissimilar polymer materials to one another. Inorganic surfaces (e.g. metals, glass, ceramics, and the like) may also be suitably bonded using a polymeric diazirine.

As a further benefit, also disclosed herein, polymeric diazirines (especially those in which polar functional groups are incorporated) may function as primers for use in activating the surface of low-functionality polymers toward interaction with other known adhesives. Such secondary (bulk) adhesives could include polyurethanes, epoxies, cyanoacrylates, or any other known adhesive.

### SUMMARY OF THE INVENTION

The invention disclosed herein comprises reinforced polymer composite materials, compounds useful in the preparation of such composites, and methods for their manufacture.

Composite materials of the invention may be prepared by first treating a polymer substrate with a polyamine-diazirine primer and treating the resulting amine-enhanced polymer with an epoxy resin in the presence of a suitable hardener.

The composite materials disclosed herein show adhesion comparable to those of higher surface energy materials and have significantly improved mechanical properties.

The invention disclosed herein comprises diazirine-containing polymers (“polymeric diazirines” or “polydiazirines”) for use in adhesion of non-biological materials. Particular aspects of the invention allow for the bonding of low-surface energy materials such as polyethylene, polyethylene terephthalate, polypropylene, fluoropolymers, and the like.

Additional aspects of the invention include the use of polymeric diazirines as surface-activating primers, which can enable other adhesives to be used to bond challenging surfaces such as low surface energy polymers, and which can be useful in the preparation of composite materials such as reinforced polymer composites.

### BRIEF DESCRIPTION OF THE DRAWINGS

The preferred embodiment of the invention will be described by reference to the drawings thereof in which:

FIG. 1 is a schematic representation of two-component epoxy systems known in the art;

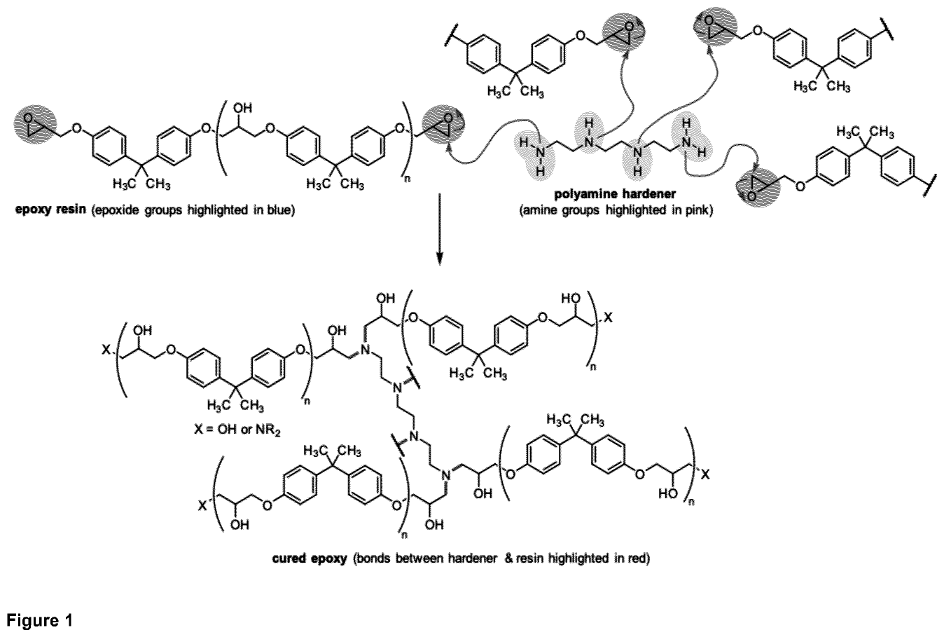

FIG. 2 is a functionalization of polyethylene using diazirines;

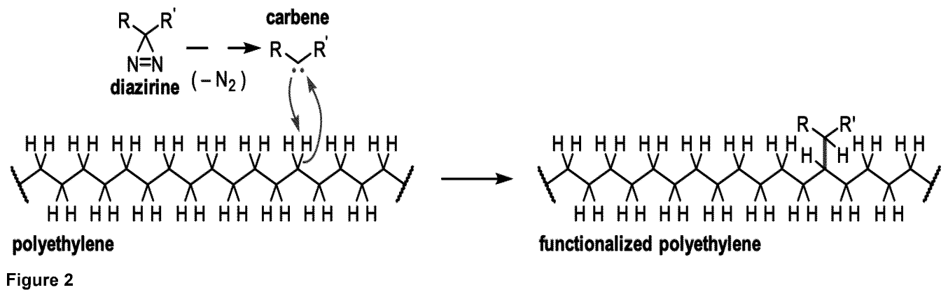

FIG. 3 is a schematic representation of the epoxy system disclosed herein. Critical new bonds are indicated in red;

FIG. 4 are exemplary diazirines useful in the practice of the invention disclosed herein;

FIG. 5 is are synthesis of diazirine-amine reagents useful in the practice of the invention. Structures for conjugates 2, 3 and 4 are meant to convey approximate statistical relationships between free amine groups and the diazirine group, and are not intended to indicate the precise locations of the diazirine group within the polyamine;

FIG. 6 is the effect of thermal activation (panel A) and photochemical activation (panel B) on primer loading. Numbers in red indicate the percent of primer retained following methanol extraction;

FIG. 7 is the reaction of epoxy resin on the surface of fabric loaded with polyamine-diazirine reagents applied using thermal activation (panel A) and photochemical activation (panel B). For all experiments, the reaction of the epoxy with the amine-functionalized surface was carried out using thermal stimulation. Numbers in red indicate the weight percent of reacted epoxy, relative to the mass of loaded primer reagent. Asterisks indicate samples that contained no measurable amount of primer and so were not carried forward to the epoxy treatment steps. Error bars indicate standard error over three replicates;

FIG. 8 is a workflow for preparation of lap-shear samples from UHMWPE bars treated with primer 4a;

FIG. 9 is the measured adhesion strength for lap-shear samples, following bonding with 10 mg or 0 mg of the epoxy/hardener mixture. White bars=no primer used. Grey bars=application of PEI. Green bars=application of primer 4a (PEI(25 k)-g-diazirine(30 wt %)). Blue bars=application of primer 4a, followed by epoxy sizing. Hashed bars=0.5 mg primer applied in the 1″×0.5″ contact region of each UHMWPE bar. Solid bars=1.0 mg primer applied in the 1″×0.5″ contact region of each UHMWPE bar. The | symbol indicates a vehicle control sample in which no epoxy/hardener mixture was added. Error bars indicate standard error;

FIG. 10 is infusion data for epoxy-UHMWPE layups. A: comparison of average infusion length (when filling a 12 cm×12 cm sample) vs. time data for UHMWPE fabrics with different surface treatments. B: comparison of calculated permeability values. White bars=no primer used. Green bars=application of primer 4c (PEI(25 k)-g-diazirine(10 wt %)). Blue bars=application of primer 4c, followed by epoxy sizing. Hashed bars=thermal activation of primer. Solid bars=UV activation of primer. Error bars indicate standard deviation for measurements made on the second and third infusions; the first run in each case was used to establish infusion parameters and so was not included in the analysis. Asterisks indicate that singleton samples were used, due to physical limitations in the UV curing apparatus;

FIG. 11 is mechanical testing data using epoxy-UHMWPE composite materials. A: representative short beam shear stress vs. extension curves for composite materials derived from UHMWPE fabrics with different surface treatments. B: comparison of average flexural yield strength measured for each sample type. White and grey bars=no primer used. Green bars=application of primer 4c (PEI(25 k)-g-diazirine(10 wt %)). Blue bars=application of primer 4c, followed by epoxy sizing. Hashed bars=thermal activation of primer. Solid bars=UV activation of primer. Error bars indicate standard error;

FIG. 12 is a activation of bis-diazirines, and utility in crosslinking polyolefin surfaces;

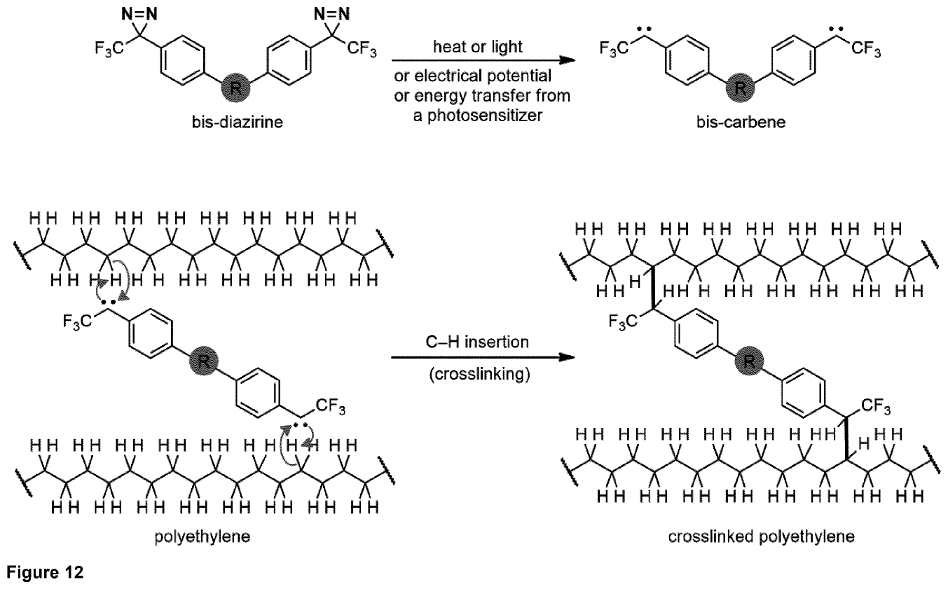

FIG. 13 is representative self-crosslinking mechanisms available for polydiazirines;

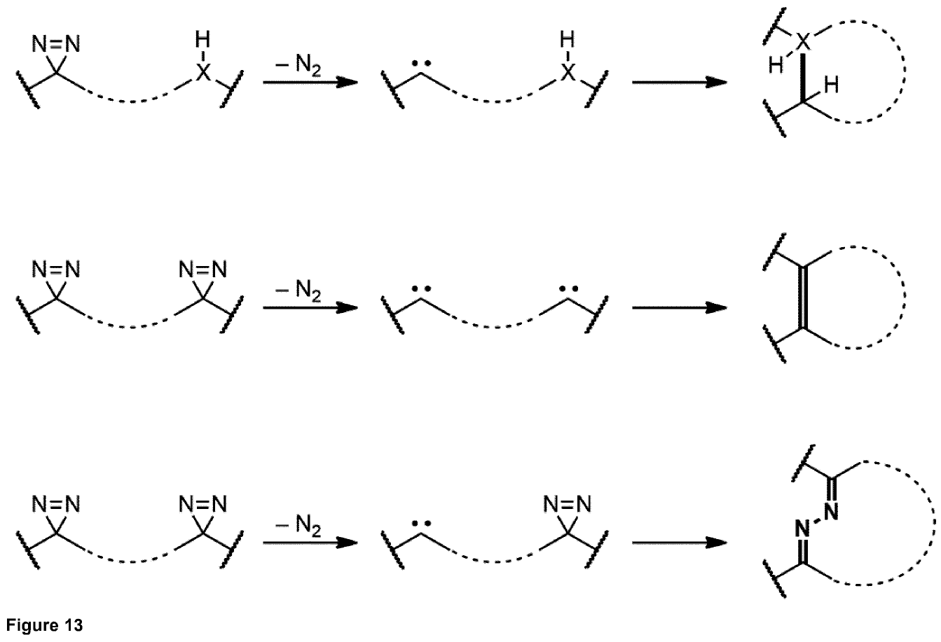

FIG. 14 is representative polydiazirines for use in adhesion. Examples are provided for illustrative purposes only, and are not intended to be limiting with regard to specific structural elements;

FIG. 15 is exemplary synthetic routes to polymeric diazirines;

FIG. 16 are specific examples of polymeric diazirine graft polymers falling within generalized structure 3a, emphasizing that such polymers may be dendrimeric or branched, and may include various salt forms;

FIG. 17 are 1H and 19F NMR (in CD30D) and IR spectra (neat) for PAMAM-g-diazirine(30 mol %) (3a-A);

FIG. 18 are 1H, 13C, and 19F NMR spectra (in CD30D) and IR spectra (neat) for PEI(800)-g-diazirine(30 wt %) (3A-B1);

FIG. 19 are 1H, 13C, and 19F NMR spectra (in CD30D) and IR spectra (neat) for PEI(25 k)-g-diazirine(30 wt %) (3A-B2);

FIG. 20 are 1H, 13C, and 19F NMR spectra (in CD30D) and IR spectra (neat) for PEI(25 k)-g-diazirine(20 wt %) (3A-B3);

FIG. 21 are 1H, 13C, and 19F NMR spectra (in CD30D) and IR spectra (neat) for PEI(25 k)-g-diazirine(10 wt %) (3A-B4);

FIG. 22 is the effect of thermal activation on diazirine polymer loading. Numerical values indicate the percent of polymer reagent retained following methanol extraction;

FIG. 23 is the reaction of epoxy resin on the surface of fabric loaded with polyamine-diazirine conjugates applied using thermal activation. Numerical values indicate the weight of reacted epoxy, relative to the mass of loaded polyamine-diazirine conjugate. Error bars indicate standard error over three replicates;

FIG. 24 is the effect of photochemical activation on diazirine polymer loading. Numerical values indicate the percent of polymer reagent retained following methanol extraction;

FIG. 25 is the reaction of epoxy resin on the surface of fabric loaded with polyamine-diazirine conjugates applied using photochemical activation. Numerical values indicate the weight of reacted epoxy, relative to the mass of loaded polyamine reagent. Asterisks indicate samples that contained no measurable amount of polyamine and so were not carried forward to the epoxy treatment step. Error bars indicate standard error over three replicates;

FIG. 26 is collected IR spectra for UHMWPE cloth treated with thermally applied 3a-B2, 3a-B3 and 3a-B4, before and after reaction with epoxy resin. In each case the polyamine-diazirine conjugate was loaded at 12.5 wt % relative to the mass of polyethylene substrate;

FIG. 27 is collected IR spectra for UHMWPE cloth treated with photochemically applied 3a-B2, 3a-B3 and 3a-B4, before and after reaction with epoxy resin. In each case the polyamine-diazirine conjugate was loaded at 12.5 wt % relative to the mass of polyethylene substrate;

FIG. 28 is IR spectra collected over 16 days, for UHMWPE cloth treated with photochemically applied 3a-B2, 3a-B3 and 3a-B4. For each treated fabric sample, absorbances corresponding to amine stretching and bending modes remained visible over the period of the experiment. In each case the polyamine-diazirine conjugate was loaded at 12.5 wt % relative to the mass of polyethylene substrate;

FIG. 29 is the average contact angle on UHMWPE surfaces to which the indicated polyamine-diazirine conjugates were applied thermally. B: Average contact angle for thermally applied polyamine-coated surfaces reacted with epoxy resin. Black bars indicate UHMWPE fabric samples that have been treated with polymeric diazirines and extracted with methanol; grey bars indicate samples that have been subsequently allowed to react with epoxy resin followed by further washing. Error bars indicate standard error over ten replicates;

FIG. 30 is the average contact angle on UHMWPE surfaces to which the indicated polyamine-diazirine conjugates were applied photochemically. B: Average contact angle for photochemically applied polyamine-coated surfaces reacted with epoxy resin. Black bars indicate UHMWPE fabric samples that have been treated with polymeric diazirines and extracted with methanol; grey bars indicate samples that have been subsequently allowed to react with epoxy resin followed by further washing. Asterisks indicate that applied water droplets were immediately drawn into the treated fibers, such that a contact angle of zero degrees was recorded. Error bars indicate standard error over ten replicates; and

FIG. 31 is a measured adhesion strength for lap-shear samples, following bonding with 10 mg or 0 mg of the epoxy/hardener mixture. White bars=no primer used. Grey bars=application of PEI. Black bars=application of (PEI(25 k)-g-diazirine(30 wt %) (3a-B2) as primer, prior to application of epoxy/hardener (with or without an intermediate surface treatment of pure epoxy resin). Hashed bars=0.5 mg primer applied in the 1″×0.5″ contact region of each UHMWPE bar. Solid bars=1.0 mg primer applied in the 1″×0.5″ contact region of each UHMWPE bar. The | symbol indicates a vehicle control sample in which no epoxy/hardener mixture was added. Error bars indicate standard error.

### DETAILED DESCRIPTION OF THE INVENTION

Disclosed herein is a method for the preparation of a polymer composite material comprising the steps of:
a) Treating a polymer substrate with a diazirine-polyamine primer; and
b) Treating the product of step (a) with an epoxy resin and curing the resulting mixture.

Optionally, the product of step (a) may be pre-functionalized (“sized”) with an initial layer of epoxy resin (in the absence of hardener) prior to the formation of a final reinforced polymer composite, as described herein.

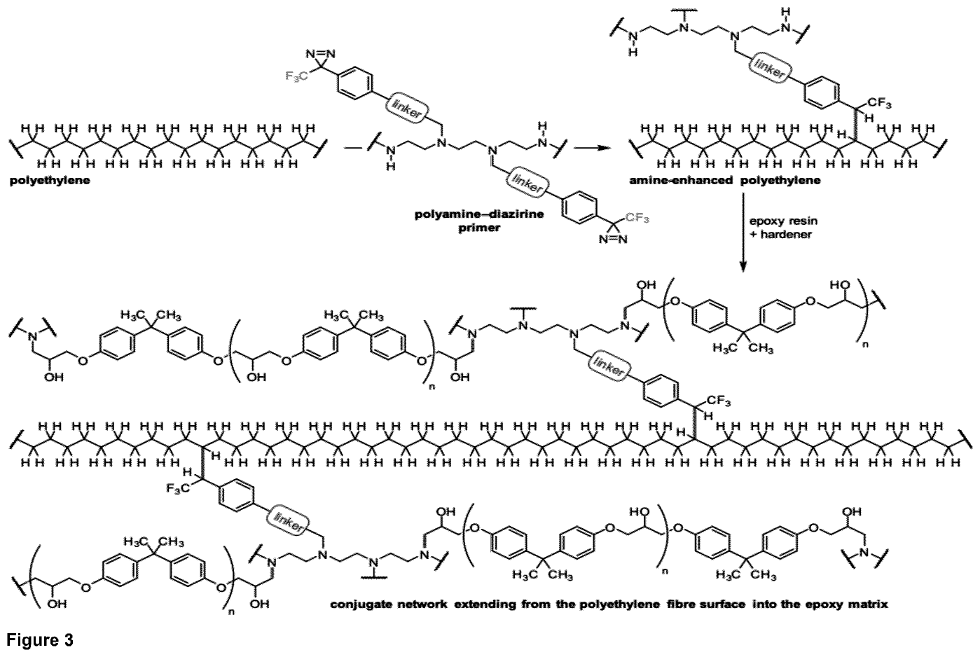

We have discovered that a series of diazirine-polyamine primers, as disclosed herein, can be used to covalently functionalize a polymer surface with amine groups, which in turn participate directly in nucleophilic addition reactions with epoxy resin (FIG. 3). This results in a strong adhesive force between the (now-functionalized) surface of the polymer and the epoxy matrix.

The term “polyamine”, as used herein, refers to an oligomeric or polymeric compound containing at least 3 repeat units, where each repeat unit is a molecular fragment defined by 1 or more nitrogen atoms covalently bonded to 1 or more carbon atoms. Exemplary polyamines include low-molecular weight (“MW”) oligomers (e.g. triethylenetetramine (TETA)), dendrimers (e.g. poly(amidoamine) (PAMAM)) and polymers (e.g. linear and branched polyethylenimine (PEI)). PEI is also referred to in the field as polyethylene polyamine.

Preferred are primers derived from PEI or PAMAM. More preferred are primers derived from linear or branched PEI with a molecular weight of at least 800 g/mol. Most preferred are primers derived from PEI with a molecular weight of 25,000 g/mol.

Diazirines useful in the preparation of the primers disclosed herein include, but are not limited to, aliphatic or aryl diazirines such as diazirine-containing benzyl halides (e.g. benzyl bromides), diazirine-containing aliphatic alkyl halides (e.g. alkyl iodides) and diazirine-containing epoxides.

Other suitable diazirines include, for example, a diazirine-containing anhydride or NHS ester (or any related carbonyl electrophile). Further examples include diazirine-containing aldehydes, or diazirines that are covalently bound to aryl halides which may be used in a wide variety of coupling reactions known to those skilled in the art. Exemplary coupling reactions that may take place at aryl halides include, but are not limited to, aryl amination reactions and SNAr reactions.

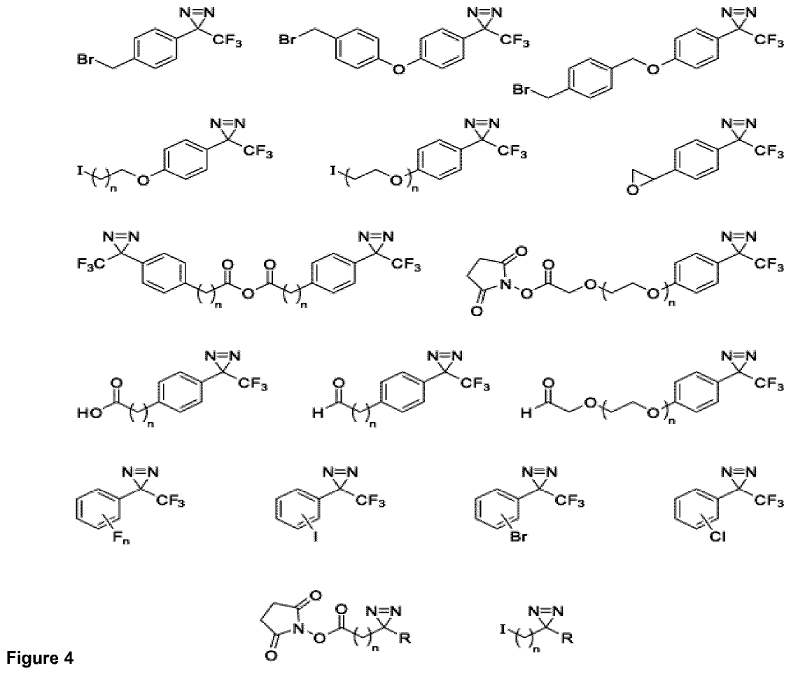

Preferred are electron-rich aryl diazirines such as those in which a trifluoromethyl aryl diazirine is connected to a linker through the use of an ether or thioether or amine linkage, in such a way that the oxygen, sulfur or nitrogen atom is capable of donating electron density through the aromatic ring to stabilize a singlet carbene Exemplary diazirines useful in the practice of the invention disclosed herein are shown in FIG. 4. A preferred diazirine is 3-[4-(bromomethyl)phenyl]-3-(trifluoromethyl)-3H-diazirine.

Diazirines useful in the preparation of the primers disclosed herein may be prepared by methods known in the art. For example, they may be prepared by oxidation of a diaziridine precursor, which may in turn be obtained from the corresponding ketone or other suitable starting reagents.

Primers useful in the practice of the invention disclosed herein contain a polyamine moiety covalently bound to a diazirine moiety. Suitable primers contain at least one diazirine group per polymer chain.

Such primers include, but are not limited to, compounds such as polyethylenimine-g-3-phenyl-3-(trifluoromethyl)-3-H-diazirine.

Primers useful in the practice if the invention disclosed herein have from about 1 to about 50 diazirine unites per polymer chain. Preferred are primers having about 10 diazirines per polymer chain.

In principle, any organic polymer which has C—H or O—H or N—H bonds may be used as a substrate in the preparation of the reinforced polymer composites of the invention.

Preferably, the polymer is a low-functionality polymer. As used herein, a low-functionality polymer is a polymer comprised principally of C—C and C—H bonds and, therefore, lacks reactive functional groups such as, for example, carbonyl groups, hydroxyl groups, amines, amide or ester linkages.

More preferably, the polymer is a polyethylene such as ultra-high molecular weight polyethylene (UHMWPE).

Polymeric substrates useful in the practice of the invention disclosed herein include, for example, pre-made objects, films, powders, sheets, bare fibres, sized fibres, mesh and ribbons. Such materials can be further processed into shapes such as braided lines or ropes, woven and non-woven fabric, alternating orthogonal layers of unidirectional fibres, knitted fabric, laminated films and mesh or web constructs.

The methods disclosed herein provide excellent functionalization of polymer surfaces and so facilitate the preparation of composite materials by reaction with epoxy resin.

Lap-shear samples prepared using the methods disclosed herein show adhesion comparable to that with higher surface energy materials-consistent with the formation of a covalent network extending from the substrate polymer surface into the epoxy matrix.

Composites prepared using the methods disclosed herein show significantly improved uptake of epoxy during the resin impregnation step (relative to untreated controls), and have significantly improved mechanical properties when challenged in subsequent three-point bending experiments.

### Primer Synthesis

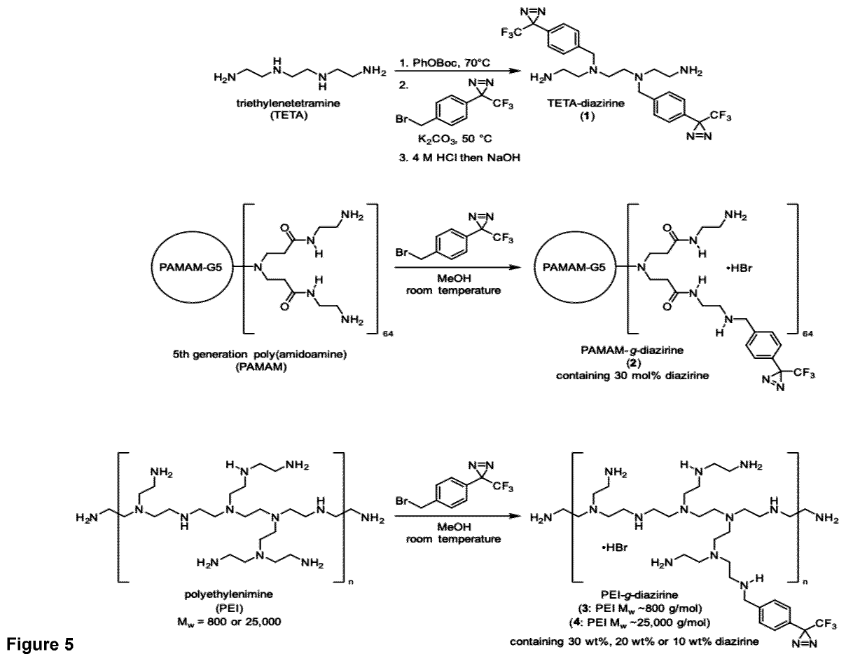

Primers suitable for use in the preparation of the composite materials disclosed herein may be prepared by methods known in the art. FIG. 5 shows the synthesis of exemplary primers useful in the practice of the invention disclosed herein.

In one embodiment, TETA-diazirine (1), was designed based upon the triethylenetetramine reagent (TETA) that is found in commercial epoxy hardener cocktails. The internal amine groups of TETA were functionalized with diazirine groups, leaving the terminal amines free for reaction with the epoxy resin.

In a second embodiment, PAMAM-diazirine conjugate (2), an example of a diazirine-amine conjugate of intermediate size, by was synthesized by treating 5^{th}-generation poly(amidoamine), containing 128 surface amine groups, with 30 mol % of 3-[4-(bromomethyl)phenyl]-3-(trifluoromethyl)-3H-diazirine.

In other embodiments, polymeric diazirine-amine conjugates 3 and 4 were prepared by treating branched polyethylenimine (800 g/mol or 25,000 g/mol) with either 30, 20, or 10 wt % 3-[4-(bromomethyl)phenyl]-3-(trifluoromethyl)-3H-diazirine. NMR analysis indicated that each diazirine-amine conjugate contained the expected ratio of labeled to unlabeled amine groups.

### Preparation of a Functionalized Polymer Substrate

In one embodiment of the invention disclosed herein, functionalized polymer substrates may be prepared by treatment of the substrate with a solution of a suitable primer. The choice of solvent will be determined by factors such as the nature of the substrate and primer, and will be readily appreciated by a person skilled in the art.

The substrate is incubated in the primer solution, after which the solvent is removed from the substrate (for example, by evaporation). The resulting primer-impregnated substrate is then treated to activate the diazirine groups (i.e. to functionalize the substrate).

Activation methods include, but are not limited to thermal, photochemical, and electrical activation. Alternatively, activation may be achieved through the use of transition metal complexes.

Thus, in one embodiment, UHMWPE fabric was incubated in a methanolic primer solution, after which the solvent was allowed to evaporate from the fabric. The resulting samples of primer-impregnated woven UHMWPE were then heated to activate the diazirine groups.

In a second embodiment, the diazirine activation was accomplished photochemically, by irradiating the primer-impregnated woven UHMWPE with UV light.

The amount of primer used in the preparation of a functionalized polymer substrate of the invention is in the range of from 0.1 weight percent to 20 weight percent, relative to the mass of the substrate. In one embodiment of the invention, primer was used in an amount of 10 weight percent, relative to the substrate. In another embodiment of the invention the amount was 5 weight percent and, in another, 1 weight percent.

In an alternative embodiment, the substrate may be treated with primer in the absence of solvent.

In yet another embodiment, the primer may be applied to the substrate by spraying rather than soaking. If a spray application is used, the primer may be applied either with or without the use of a dispersing solvent.

For substrates comprising woven or non-woven fibres, or braided lines or ropes, it may be advantageous to use a vacuum or high pressure to facilitate higher penetration of the primer (with or without a solvent) into the substrate.

The primers described herein can also be incorporated into the polymer material itself by, for example, by pressure or solvent infusion, where such infusion substantially disperses the primer within the polymer.

Such infusion can be accomplished by dissolving the primer in, for example, a volatile organic solvent (which can be removed prior to activation) at a temperature which does not melt the polymer or cause the primer to activate. Optionally, a vacuum can be first applied to achieve higher penetration in materials constructed of braided, woven and non-woven fibres, bare fibres or strands of fibres.

Alternatively, the primer can be pressure infused with or without the use of a solvent carrier.

The addition of a primer can also be accomplished by adding the primer directly into the polymer melt or extrudant. However, such processes are limited to polymers having a melt temperature lower than that of the primer activation temperature, unless such primer is activated non-thermally.

Such low melting point polymers include, for example, paraffin, polylactic acid and polycaprolactone.

### Addition of an Epoxy Sizing

In certain embodiments, it is beneficial to pre-react (“size”) a functionalized substrate with an initial layer of epoxy resin (in the absence of hardener), prior to the formation of a final reinforced polymer composite.

In an exemplary embodiment, UHMWPE that had been functionalized with polyethylenimine-g-3-phenyl-3-(trifluoromethyl)-3-H-diazirine (using either thermal or photochemical activation of the diazirine groups to facilitate covalent linking to the UHMWPE fibre) was incubated in a methanolic solution of a commercial epoxy resin (West System Epoxy 105). Reaction between surface-bound amine groups and epoxy resin was achieved by heating at 110° C. Washing and re-weighing the sample confirmed that the treated UHMWPE sample was able covalently bind approximately 2 mg of epoxy resin for every 1 mg of primer that had been covalently linked to the UHMWPE surface.

It will be understood by those skilled in the art that pre-functionalization of the primer-treated UHMWPE by an initial layer of epoxy resin may increase stability for long-term storage (since oxidation of surface-bound amines will no longer present a limitation) or may increase subsequent interaction with epoxy/hardener mixtures when forming bulk composite materials.

### Preparation of a Composite Material

Composite materials of the invention may be prepared by treatment of a functionalized polymer substrate with an epoxy resin using methods well known in the art.

In certain embodiments, the functionalized polymer is UHMWPE that has been treated with a polyamine-diazirine primer of the type disclosed herein. In other embodiments, the functionalized polymer is UHMWPE that has been treated with a polyamine-diazirine primer and then subsequently treated with an initial layer of epoxy resin (“sized”).

In an alternative embodiment, epoxy curing may be carried out photochemically.

In certain embodiments it may not be necessary to apply heat; the exothermic nature of the reaction between the amine and the epoxide is sufficient to effect curing.

In certain embodiments (for example very thin composite materials) the primer itself could function as the hardener.

In an exemplary embodiment, UHMWPE that had been treated with polyethylenimine-g-3-phenyl-3-(trifluoromethyl)-3-H-diazirine (using either thermal or photochemical activation of the diazirine groups to facilitate covalent linking to the UHMWPE fibre, and where an epoxy sizing layer was either present or absent) was formulated into a composite material using a standard commercial epoxy and hardener system (Rhino Linings 1411/4111) using a vacuum infusion protocol.

Primer-treated UHMWPE had a much higher permeability to the epoxy/hardener mixture than untreated or vehicle control UHMWPE. As a result, the vacuum infusion proceeded much more rapidly with primer-treated samples. Samples in which the primer had been applied using UV methods had a higher permeability than samples in which the primer was applied thermally. Samples in which a sizing layer of epoxy was added had a higher permeability than samples in which this layer was absent.

Certain reinforced polymer composites prepared from primer-treated UHMWPE had superior flexural yield strength to reinforced polymer composites prepared from untreated or vehicle-control samples.

### Examples

### General Procedure: Synthesis of PEI-g-Diazirine

A solution of commercially available branched polyethylenimine (PEI) (average MW 25K or 800) in methanol (completely homogenous after sonication) was bubbled with nitrogen or argon for 2 minutes. Then, the desired amount of 3-(4-(bromomethyl)phenyl)-3-(trifluoromethyl)-3H-diazirine was added dropwise and the reaction mixture was stirred at room temperature for 72 h in the dark. The solvent was evaporated on a rotary evaporator at room temperature, covered by aluminum foil, and the reaction mixture was dried under vacuum.

### PEI(25K)-g-Diazirine (30 wt %).

Following the general procedure, PEI (25K) (350 mg) was dissolved in 20 mL of methanol and 3-(4-(bromomethyl)phenyl)-3-(trifluoromethyl)-3H-diazirine (150 mg, 30 wt %) was added to the reaction mixture to yield a pale-yellow viscous liquid. ¹H NMR (500 MHz, CD30D) δ 7.60-7.39 (m), 7.36-7.12 (m), 3.95-3.56 (m), 3.02-2.35 (m). ¹³C NMR (126 MHz, CD30D) b 143.37, 130.83, 130.24, 128.55, 127.59, 123.60 (q, J=273.9 Hz), 59.74, 56.69, 54.78, 53.72, 52.26, 52.11, 41.67, 41.62, 41.56, 39.81, 29.45 (q, J=41.2 Hz). ¹⁹F NMR (471 MHz, CD30D) δ −66.69.

### PEI(25K)-g-Diazirine (20 wt %).

Following the general procedure, PEI (25K) (400 mg) was dissolved in 20 mL of methanol and 3-(4-(bromomethyl)phenyl)-3-(trifluoromethyl)-3H-diazirine (100 mg, 20 wt %) was added to the reaction mixture to yield a pale-yellow viscous liquid. ¹H NMR (500 MHz, CD30D) δ 7.63 (d, J=8.0 Hz), 7.47-7.20 (m), 4.04-3.76 (m), 3.11-2.49 (m). ¹³C NMR (126 MHz, CD30D) b 143.62, 130.82, 130.25, 128.56, 127.61, 123.62 (q, J=273.8 Hz), 55.08, 53.84, 52.52, 48.04, 41.79, 39.97, 29.44 (q, J=38.8 Hz). ¹⁹F NMR (471 MHz, CD30D) 5-66.68. IR (diamond-ATR) v: 3269, 2934, 2812, 1607, 1517, 1456, 1344, 1297, 1233, 1152, 1154, 1111, 1035, 938, 869, 764, 735 cm⁻¹.

### PEI(25K)-g-Diazirine (10 wt %).

Following the general procedure, PEI (25K) (450 mg) was dissolved in 20 mL of methanol and 3-(4-(bromomethyl)phenyl)-3-(trifluoromethyl)-3H-diazirine (50 mg, 10 wt %) was added to the reaction mixture to yield a pale-yellow viscous liquid. ¹NMR (500 MHz, CD30D) b 7.82-7.53 (m), 7.40 (d, J=7.7 Hz), 3.93 (d, J=64.3 Hz), 3.12-2.43 (m). ¹³C NMR (126 MHz, CD30D) δ 143.62, 130.73, 130.24, 127.63, 123.64 (q, J=274.3 Hz), 57.47, 55.10, 53.91, 52.79, 48.49, 41.90, 40.14, 29.49 (q, J=39.2 Hz). ¹⁹F NMR (471 MHz, CD30D) δ −66.75. IR (diamond-ATR) v: 3272, 2933, 2810, 1603, 1456, 1345, 1295, 1233, 1182, 1113, 1034, 938, 768 cm⁻¹.

### PEI(800)-g-Diazirine (30 wt %).

Following the general procedure, PEI (800) (350 mg) was dissolved in 20 mL of methanol and 3-(4-(bromomethyl)phenyl)-3-(trifluoromethyl)-3H-diazirine (150 mg, 30 wt %) was added to the reaction mixture to yield a pale-yellow viscous liquid. ¹H NMR (500 MHz, CD30D) b 7.70-7.52 (m), 7.42-7.23 (m), 4.01-3.78 (m), 3.04-2.48 (m). ¹³C NMR (126 MHz, CD30D) b 143.40, 130.81, 130.34, 130.25, 128.58, 128.50, 127.61, 123.62 (q, J=274.1 Hz), 59.77, 57.02, 56.68, 54.94, 54.86, 54.78, 52.39, 52.36, 52.27, 49.70, 48.05, 41.77, 41.72, 41.68, 41.58, 39.89, 29.46 (q, J=40.4 Hz). ¹⁹F NMR (471 MHz, CD30D) δ −66.74. IR (diamond-ATR) v: 3273, 2933, 2812, 1607, 1456, 1344, 1297, 1233, 1182, 1155, 1117, 1035, 938, 808 cm⁻¹.

### Synthesis of PAMAM-g-Diazirine (30%).

Commercially available poly(amidoamine) dendrimer (PAMAM, fifth generation, 28.8 kDa, with 128 amino termini) 5 wt % solution in methanol (2.4 mL, 103.8 mg PAMAM, 0.46 mmol NH2) was diluted to 0.5 wt % in methanol. 3-[4-(bromomethyl)phenyl]-3-(trifluoromethyl)-3H-diazirine (38.6 mg, 0.138 mmol) was added to the PAMAM/methanol solution, for a theoretical yield of 30% mol/mol diazirine/PAMAM NH2. The reaction was vigorously stirred for 32 h at room temperature in the dark and evaporated under vacuum to yield a pale-yellow viscous liquid (160 mg). ¹H NMR (300 MHz, CD30D) b 7.45, 7.19, 3.80, 3.34, 2.99-2.64, 2.59, 2.38. ¹⁹F NMR (283 MHz, CD30D) δ −66.75. IR (diamond-ATR) v: 3265, 3072, 2934, 2827, 1634, 1543, 1462, 1343, 1287, 1232, 1183, 1151, 1028, 938, 810 cm⁻¹.

### Impregnation of UHMWPE Fabric

The primer (PEI-, PAMAM-, or TETA-g-diazirine) was applied to the fabric via impregnation. The fabric used was UHMWPE 75 g/m² fabric made of woven fibers (200 denier).

### Procedure

The UHMWPE 75 g/m² fabric was impregnated with the primer by placing a piece of desired dimensions into a close-fitting aluminum pan filled with the primer solution in methanol at the desired concentration. The concentration of primer was calculated to impregnate the fabric with 1 wt %, 5 wt %, and 10 wt %, but to compensate for primer deposited on the sides and bottom of the aluminum pan, an extra circa 0.25 wt %, 1.5 wt % or 2.5 wt % (resp.) were added: for a given piece of fabric, the amount of primer in the solution was 1.25 wt %, 6.5 wt % or 12.5 wt % (resp.) of its mass. The bath was covered with aluminum foil and left to sit at room temperature for 30 minutes. Then, the cover was removed to allow the methanol to evaporate in a fume hood for 30 minutes and the samples were hanged in the fume hood for additional 30 minutes.

Control samples were prepared following the same procedure but without adding primer in the methanol bath.

Thermal activation of primer: After methanol evaporation, the impregnated fabric sheets were wrapped in aluminum foil and placed in an oven at 110° C. for 4 hours.

UV activation of primer: After methanol evaporation, the impregnated fabric sheets were placed in a UV chamber for 16 hours and irradiated with 360 nm light.

Extraction of fabric: After primer thermal and UV crosslinking, the samples were weighed to determine the total mass of reacted primer with fabric. Each piece was then washed 3 times for 5 min at room temperature with methanol to remove unreacted primer and possible side products which were not attached to the fabric. After drying the primer-treated fabrics in an oven (5 min at 100° C.), each sample was weighed again to determine the mass of reaction products that were lost during the methanol washing.

### Epoxy Sizing

The thermally and UV-treated fabrics were placed in close-fitting aluminum pans, followed by the addition of West 105 epoxy resin solution in methanol. The mass of epoxy resin used was approx. 2 times the total mass of the fabric. The bath was left sitting at room temperature for 30 minutes to allow the methanol to evaporate in a fume hood and the samples were placed in an oven at 110° C. for 16 hours. After epoxy treatment, each piece of fabric was extracted 3 times with methanol and 3 times with dichloromethane for 5 min at room temperature to remove the excess of unreacted epoxy resin that was not attached to the fabric. After drying the epoxy-treated fabrics in an oven (5 min at 100° C.), each sample was weighed again to determine the mass of covalently-bound epoxy.

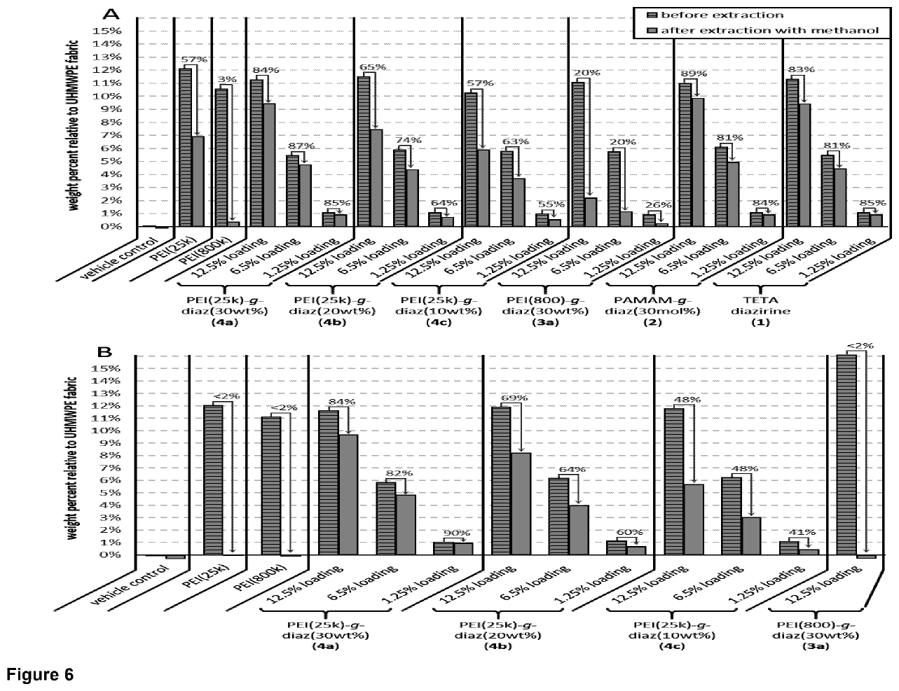

The data (FIG. 6A) indicated that the soaking procedure was successful in impregnating primer into each fabric sample (i.e., ca. 10%, 5% or 1%; refer to the blue bars in FIG. 6A). Following extraction with methanol, an average of 85% of the primer was retained in the PEI(25 k)-g-diazirine(30 wt %) samples (4a) and the PAMAM-g-diazirine(30 mol %) samples (4b; compare orange bars for the samples following methanol extraction to blue bars for the unextracted samples). The amount of retained primer decreased with decreasing diazirine loading. For the PEI(25 k)-g-diazirine(20 wt %) samples (4b) an average of 68% of the primer was retained, and for the PEI(25 k)-g-diazirine(10 wt %) samples (4c) an average of 59% was retained. PEI(25 k) control samples also retained mass, due to the known thermal decomposition of PEI.

For the remaining two primers, TETA-diazirine (1) was retained at an average of 83% of its initial impregnation mass, while PEI(800)-g-diazirine(30 wt %) (3a) was retained at 22%, relative to the initial impregnation. By contrast, only 3% of the initial impregnation mass was retained in the PEI(800 k) control sample.

Reaction of Primer-Treated Fabric with Epoxy Resin
1. Addition of Epoxy Resin to UHMWPE with Thermally Applied Primer

A sample of treated fabric was first cut into three ca. 100 mg portions (to permit replicate analysis of epoxy loading) and then exposed to a methanolic solution of a commercial epoxy resin (West System Epoxy 105). The sample was incubated at 110° C. for 16 h to facilitate the targeted nucleophilic addition reaction illustrated in FIG. 3, between surface-bound amines and electrophilic epoxide groups present in the epoxy resin.

Following the reaction, each sample was extracted 3 times with methanol and 3 times with dichloromethane to remove any unreacted epoxy resin.

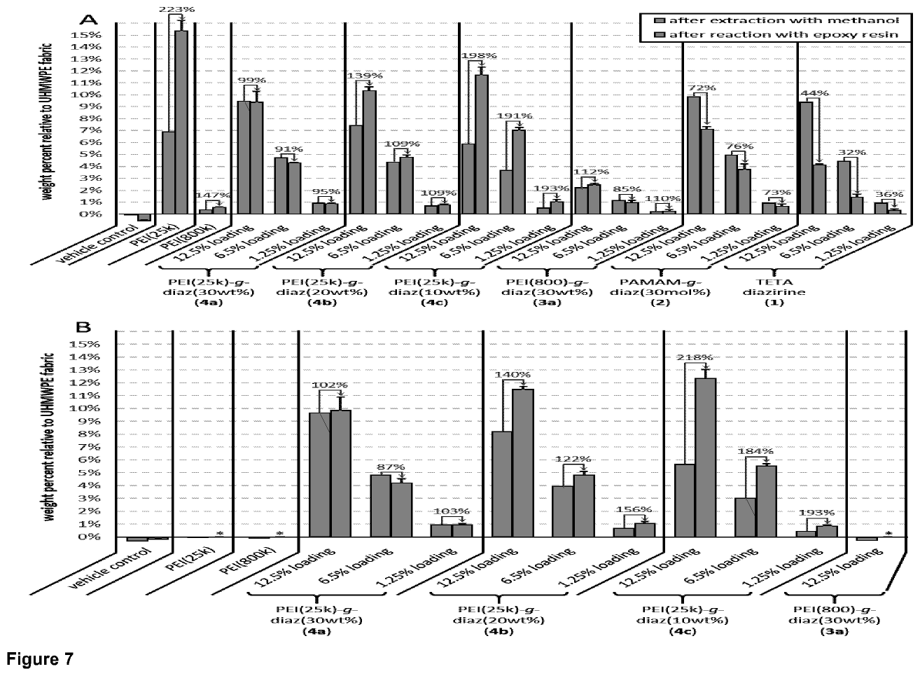

The vehicle control samples did not add any epoxy resin, and in fact showed a small mass loss due to the extensive washing protocol removing soluble impurities from the UHMWPE fabric itself. By contrast, each sample of functionalized substrate exhibited an increase in mass, resulting from the reaction of epoxy with the substrate. As shown in FIG. 7A, the amount of increase in mass depended on the type of primer used in the loading experiment, as well as the amount of primer that had been added in the preceding step. PEI(25 k)-g-diazirine(30 wt %) samples (4a) gained an average amount of epoxy corresponding to 95% of the mass of added primer. In other words, for every milligram of primer added in the initial UHMWPE functionalization step, 0.95 mg of epoxy was bound to the surface in the subsequent nucleophilic addition step. The ratio increased for PEI(25 k) primers that contained a higher level of free amines (i.e. those that had fewer nucleophilic positions blocked through the addition of diazirines). Thus, the PEI(25 k)-g-diazirine(20 wt %) samples (4b) gained an average of 119% epoxy, relative to the amount of primer, while the PEI(25 k)-g-diazirine(20 wt %) samples (4c) gained an average of 194%.

The other primers behaved in a similar fashion.

For example, PEI(800)-g-diazirine(30 wt %) (3a) experienced a similar relative increase in mass (1.02 mg added epoxy for every mg of surface-bound primer) to the analogously functionalized PEI(25 k)-g-diazirine(30 wt %) (4a; 0.95 mg added epoxy per mg of primer). PAMAM-g-diazirine(30 wt %) (2) added an average of 0.74 mg of epoxy for every mg of surface-bound primer 2. TETA-diazirine 1, added an average of only 0.37 mg of epoxy for every mg of surface-bound amine reagent.

2. Addition of Epoxy Resin to UHMWPE with Photochemically Applied Primer

Primers 4a-c as well as primer 3 and control polyamines PEI(25 k) and PEI(800 k) were applied to the same woven 75 g/m² UHMWPE fabric as described above, but this time the samples were placed under a 365 nm light source for 16 hours instead of being incubated in an oven.

PEI(25 k)-g-diazirine(30 wt %) (4a) was retained at an average level of 85%, while PEI(25 k)-g-diazirine(20 wt %) (4b) was retained at an average level of 64%, and PEI(25 k)-g-diazirine(10 wt %) (4c) was retained at an average level of 46%.

The epoxy reaction protocol described above was repeated for the UV-activated samples. As shown in FIG. 7B, a clear increase in the amount of reacted epoxy as the number of available amine groups was increased was observed across the series 4a+4b+4c. Samples treated with PEI(25 k)-g-diazirine(30 wt %) (4a) gained an average of 0.98 mg epoxy for each mg of primer present on the surface of the fabric, while samples treated with PEI(25 k)-g-diazirine(20 wt %) (4b) gained an average of 1.39 mg epoxy for each mg of surface-bound primer. Most impressively, samples treated with PEI(25 k)-g-diazirine(10 wt %) (4c) gained an average of 1.98 mg epoxy for every mg of primer.

### Lap-Shear Experiments to Test UHMWPE-Epoxy Adhesion Strength

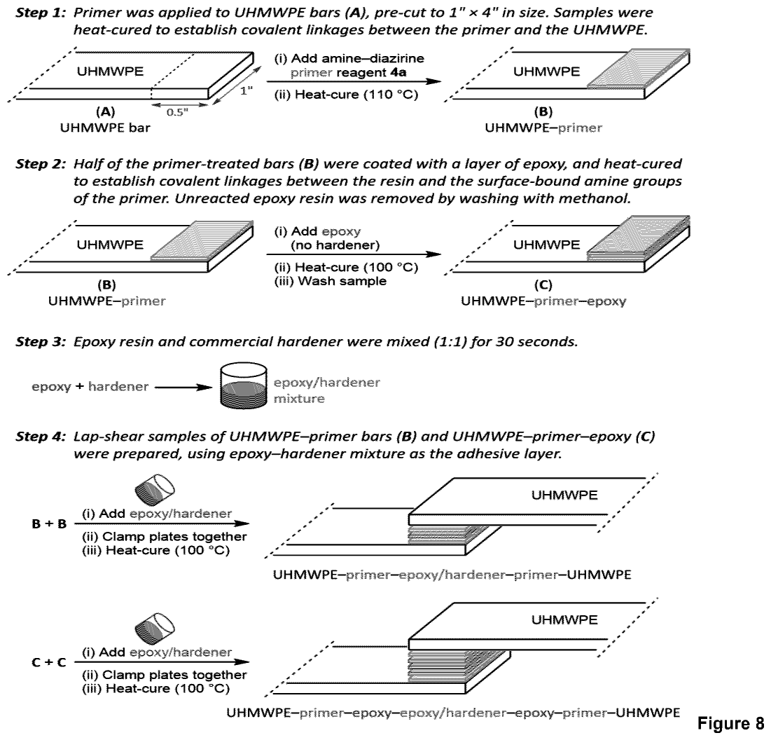

A successful fibre-reinforced composite requires that there be a strong adhesive force between the fibre and the polymer matrix. To explicitly probe the adhesive force between primer-coated UHMWPE and epoxy resin, we constructed lap-shear samples from UHMWPE bars treated with PEI(25 k)-g-diazirine(30 wt %) (4a), using a mixture of epoxy resin and commercial hardener (West System 205) as the adhesant (refer to FIG. 8 for details of sample preparation). Positive controls included higher-surface energy materials-poly(methyl methacrylate) and aluminum metal-bonded using the same epoxy/hardener mixture, to determine the maximum tensile strength expected for the particular commercial epoxy system that was being used in our experiments. Negative controls included untreated UHMWPE bars bonded with epoxy/hardener, to determine the effectiveness of epoxy for the virgin polyethylene material.

Lap-shear samples were prepared from simple primer-treated bars (i.e. B+B, FIG. 8) as well as samples from primer-treated UHMWPE that had been initially reacted (‘sized’) with epoxy resin (i.e. C+C, FIG. 8).

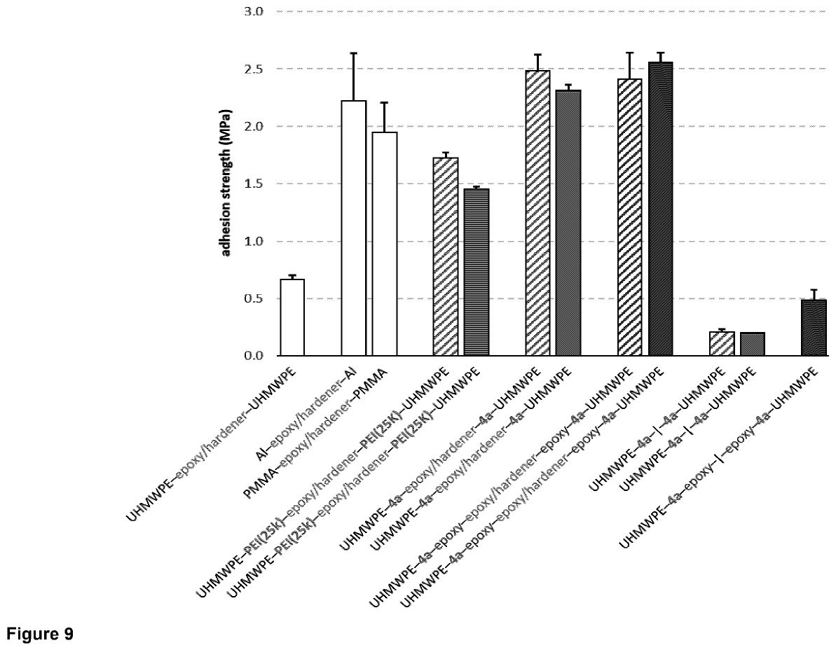

To measure the adhesive strength, each sample was pulled laterally at 3 mm/min until failure, and the force required to break the joint (divided by the 0.5 in² area used for the overlap region) was plotted in FIG. 9. The data indicated that negative control samples (i.e. UHMWPE bars bonded with the epoxy/hardener mixture) displayed low adhesion strengths of ca. 0.67 MPa, as expected for a low surface energy material. By contrast, positive control samples (i.e. aluminum-epoxy/hardener-aluminum or PMMA-epoxy/hardener-PMMA) showed higher adhesion strengths of ca. 2 MPa.

UHMWPE bars that had been treated with primer 4a (or with 4a and an epoxy sizing) prior to application of the epoxy/hardener mixture showed significantly increased adhesion relative to the negative control samples. In fact the adhesion strength exceeded that of the positive controls, reaching ca. 2.5 MPa.

The data in FIG. 9 strongly suggest the existence of a covalent network between the epoxy matrix and the primer that is covalently bound to the UHMWPE surface. In order to confirm the presence of this network (by ruling out the possibility that a simple increase to the substrate polymer's surface energy is responsible for improved adhesion) we carried out one final experiment in which the hardener reagent was left out of the adhesant layer. Specifically, a layer of epoxy (with no hardener) was sandwiched between two UHMWPE bars that had each been pre-treated with 1.0 mg of 4a, and the resulting lap-shear sample was heated for the same amount of time that had been used for the epoxy/hardener samples described above. Testing revealed an adhesion strength of 1.11±0.06 MPa-less than the 2.5 MPa observed for the test samples in FIG. 9, but much more than the 0.2 MPa measured in the primer controls. Because epoxy resin itself (i.e. in the absence of hardener) is a poor adhesive, this result unambiguously confirms the existence of covalent bonds between the epoxy and the amine-treated surface.

### Epoxy Infusion and 3-Point Bending Tests

In order to evaluate the effect of the optimized polyamine-diazirine primer upon subsequent composite material manufacturing and performance metrics, we coated >4.7 m2 of UHMWPE fabric with nominal loadings of either 0 or 1 wt % of primer 4c (PEI(25 k)-g-diazirine(10 wt %)). Diazirine activation in primer-impregnated samples was accomplished thermally (110° C. for 4 hours) or photochemically (365 nm for 16 hours), after which the fabric was extracted three times with methanol to remove unbound primer. Half of the primer-treated samples were then further reacted with epoxy (110° C. for 16 hours) and then washed three times with methanol and three times with dichloromethanane to remove any resin that was not covalently linked to the surface. Each piece of fabric was weighed at multiple steps throughout the process (refer to the Supporting Information for details) to ensure that the expected amounts of primer and/or epoxy sizing were successfully added at each stage.

Vehicle control fabrics, primer-treated fabrics, and primer-and-epoxy-treated fabrics were then assembled into 30-layer stacks of fabric 12 cm long×12 cm wide, in a vacuum-bag resin-infusion apparatus. A commercial epoxy/hardener mixture suitable for the manufacture of high-performance composites (Rhino 1411/4111) was applied under constant vacuum, and the impregnation of the resin into the fabric was monitored over time, in order to assess the effective permeability of the fabric to the epoxy/hardener mixture.

In a typical infusion experiment, 106.7 g of hardener (degassed for 1.5 hours prior to use) was combined with 32 g of hardener (degassed for 1.5 hours prior to use), and the resulting mixture was degassed for 15 minutes prior to use. The resin/hardener mixture was then applied to a 30-layer stack of 12 cm×12 cm fabric (where each layer of fabric had an areal density of approximately 75 g/m²), to achieve a laminate circa 5 mm thick, with a fibre volume fraction of 48%±2%. The progress of the epoxy/hardener mixture penetrating the fabric was followed over a period of 15 minutes, and a pressure differential of 101325 Pa was assumed. The viscosity of the resin/hardener mixture varied from 1.15 to 1.61 Pa·S. To minimize porosity, the sample was left under vacuum for at least 1 day prior to the post-curing step described below.

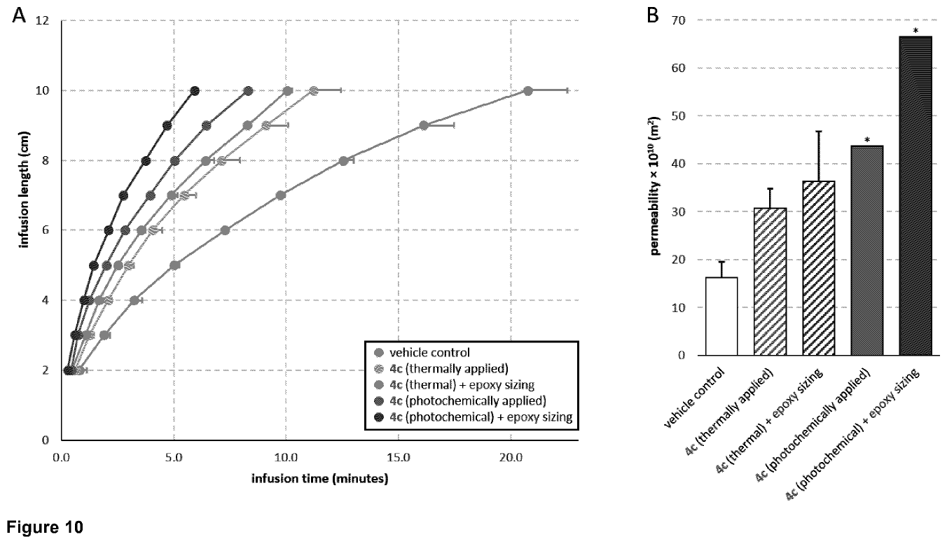

The permeability of the primer-treated samples was found to be significantly higher than those of the vehicle control samples (FIG. 10). Samples in which an initial layer of chemically bound epoxy resin had been added to the epoxy prior to infusion had an even greater permeability.

The permeability of a fabric is a measure of how rapidly a fluid of defined viscosity (in this case epoxy resin) can be drawn through the material, under the application of a given pressure differential. Because the applied macroscopic pressure drop was constant for the five types of samples compared in FIG. 10, the dramatic difference in filling performance is attributable entirely to differences in microscopic capillary forces between the surface of the treated or untreated UHMWPE fibre and the resin/hardener mixture. Consistent with our initial hypothesis, the presence of the chemically bound polyamine primer evidently makes the UHMWPE fabric surface more accommodating to the applied epoxy resin, resulting in a much larger observed flow rate (relative to vehicle control samples) and a higher permeability. Covalent linking of an initial epoxy layer onto the primer-treated surface further improves the affinity of the surface for the epoxy/hardener mixture. UV activation of the primer appears to slightly enhance this interaction between the surface and the resin, relative to thermal activation—with or without the use of an epoxy sizing step.

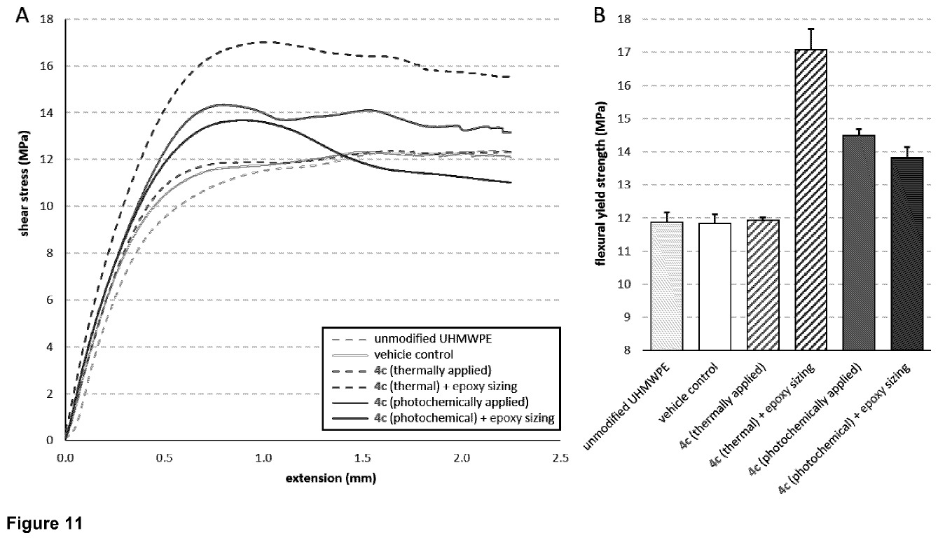

The various epoxy/UHMWPE composite materials described above were post-cured according to the resin manufacturer's recommended cure cycle (4 hours at 65° C. followed by 2 hours at 85° C.), and then rectangular samples (9 mm×29 mm) were cut from each material for mechanical testing using a standard 3-point bending experiment (ASTM D2344). As shown in FIG. 11, we observed consistent mechanical strength for composite materials prepared from unmodified UHMWPE or from vehicle control fabrics that had been exposed to our dispersal solvents and heating conditions, but where no primer was added. Interestingly, however—and once again in keeping with our central hypothesis—the altered surface chemistry achievable using polyamine-diazirine 4c was shown to affect the mechanical strength of the composite.

While the measured flexural yield strength remained modest for all samples (<20 MPa), significant differences were found depending upon the surface treatment that was used. Thermal application of primer 4c resulted in no improvement to mechanical strength relative to control samples (perhaps because the presence of poorly bound polymer aggregates from thermally induced PEI degradation counteracts the beneficial effects of the primer), but clear improvements were seen by either using a photochemical activation method in place of thermal activation or else by adding an epoxy sizing. Interestingly, the addition of a covalently bound layer of epoxy does not improve the performance of composite materials derived from primer-coated UHMWPE where the primer was applied photochemically, while the application of epoxy sizing to fabric that had gone through a thermal primer-coating step provided the best overall performance. These differences are likely attributable to the aggregation state of the polyamine; detailed characterization of these aggregates is beyond the scope of the present study.

All UHMWPE-epoxy composites underwent inelastic deformation as a result of the 3-point bending experiment, rather than the brittle failure that would be expected for a similarly constructed fibreglass-epoxy or carbon-fibre-epoxy composite. The lack of brittle failure in these samples highlights the potential utility of UHMWPE-composite materials for applications where mechanical fracture must be avoided.

In another aspect of the invention disclosed herein, polymeric diazirines may be used as adhesives for low surface energy substrates, and, in particular, for the adhesion of low-surface energy polymers such as polyethylene, polypropylene and the like. Such use is termed “single-agent adhesion”.

In another aspect of the invention disclosed herein, polymeric diazirines may function as primers for use in activating such low surface energy substrates toward interaction with other known adhesives. Such secondary (bulk) adhesives could include polyurethanes, epoxies, cyanoacrylates, or any other known adhesive. Such use is termed “secondary adhesion” or “dual-agent adhesion”.

In yet another aspect of the invention, the methods disclosed herein may be used for the preparation of reinforced polymer composite materials having significantly improved properties compared to those known in the art.

As used herein, the term “polyethylene” encompasses polymers such as HDPE, LDPE, LLDPE, UHMWPE, and XLPE, as well as polyethylene copolymers and the like.

As used herein, the term “fluoropolymer” encompasses PTFE, FEP, PFA, and the like.

The term “polyamine”, as used herein, refers to an oligomeric or polymeric compound containing at least 3 repeat units, where each repeat unit is a molecular fragment defined by 1 or more nitrogen atoms covalently bonded to 1 or more carbon atoms. Exemplary polyamines include low-molecular weight (“MW”) oligomers (e.g. triethylenetetramine (TETA)), dendrimers (e.g. poly(amidoamine) (PAMAM)) and polymers (e.g. linear and branched polyethylenimine (PEI)). PEI is also referred to in the field as polyethylene polyamine.

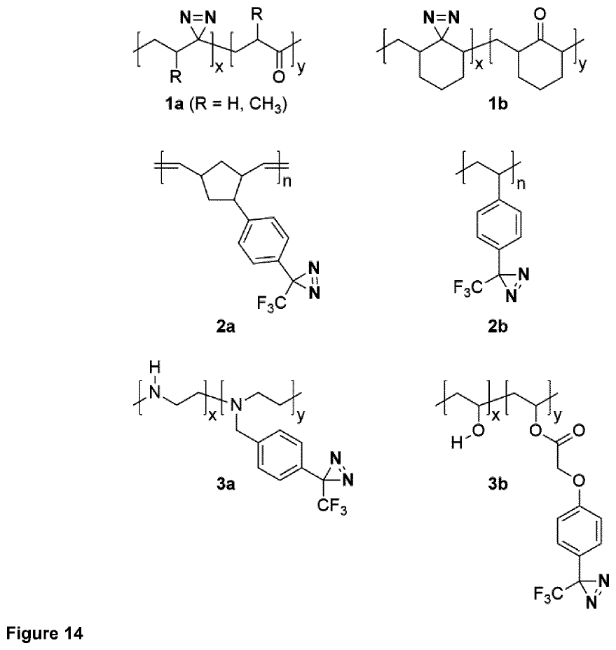

Several different types of polymeric diazirines may be envisioned for use in adhesion of commodity plastics and related materials. Without limiting the scope of the invention, these may generally be divided into three classes:
(1) polymers in which the diazirine is included within the backbone of the polymer (e.g. 1a or 2a or the like, FIG. 14);
(2) polymers in which the diazirine is included within the sidechain of the polymer (e.g. 2a or 2b or the like, FIG. 14);
(3) polymers in which the diazirine is grafted onto a suitable prepolymer containing reactive residues (e.g. 3a or 3b or the like, FIG. 14). It will be understood by those skilled in the art that the reactive residues harnessed within a prepolymer for this purpose may include nucleophilic sites, electrophilic sites, or other reactive motifs.

It will further be understood by those skilled in the art that the definition of polymeric diazirines includes block copolymers, random copolymers and statistical copolymers in which the diazirine moiety is incorporated at regular or irregular intervals within the polymer chain.

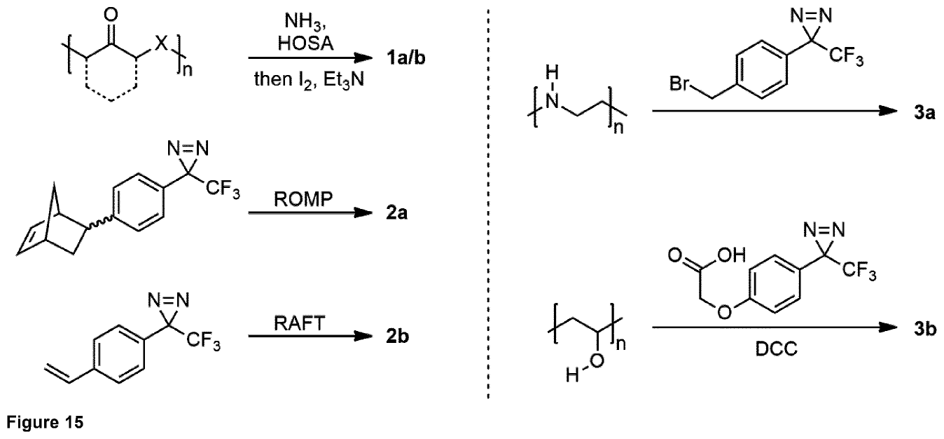

It will likewise be understood that such polymers may be synthesized from a diazirine-containing monomer, or may alternatively be synthesized from a suitable polymeric precursor by carrying out chemical reactions known to result in the conversion of a different functional group into a diazirine. For example, polymers of 2a and 2b may be accessed through ring-opening metathesis polymerization of a diazirine-substituted norbornene and by radical, anionic, or RAFT polymerization of a diazirine-substituted styrene (FIG. 15), while polymers of 1a and 2a may be accessed through reaction of a suitable polyketone with hydroxylamine-O-sulfonic acid (HOSA) and ammonia, followed by oxidation. By contrast, graft polymers such as 3a and 3b may be accessed by reacting a suitable starting polymer with a reagent that contains a diazirine group.

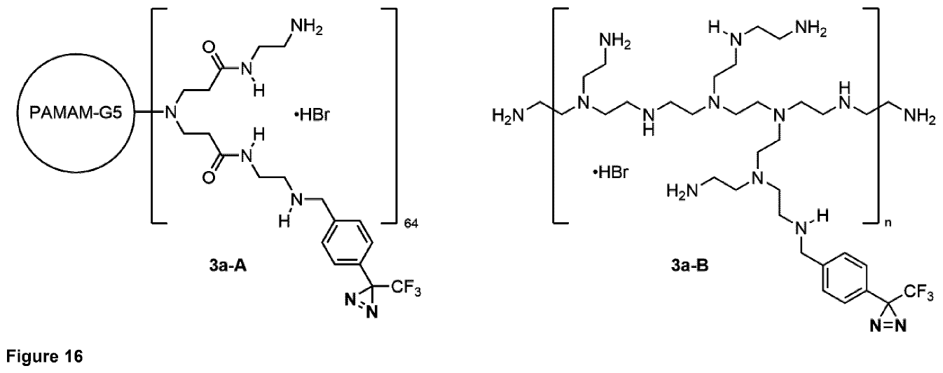

Furthermore, it will be understood by those skilled in the art that the polymer chains may be linear, branched, or dendrimeric, and may include various salt forms. For example, the generalized structure for polymer 3a indicated in FIG. 14 is understood to include the dendrimeric and branched structures (3a-A and 3a-B, respectively) illustrated in FIG. 16.

It will likewise be understood that for any of polymers 1-3 (or similarly constructed polymeric diazirines claimed herein), the diazirine moiety

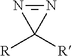

may be connected to a variety of other functional groups. Thus, R or R′ may independently be chosen from aliphatic or aromatic groups. If aliphatic groups are chosen, these may be linear or cyclic or branched. If aromatic groups are chosen, these may be electron rich, electron poor, or electron neutral. A variety of linker motifs may also be employed to attach the diazirine group to the polymer. Linkers may include bivalent alkyl groups, esters, ethers, amides, or any similar linking group.

Consequently, diazirines useful in the preparation of the primers disclosed herein include, but are not limited to, aliphatic or aryl diazirines such as diazirine-containing benzyl halides (e.g. benzyl bromides), diazirine-containing aliphatic alkyl halides (e.g. alkyl iodides) and diazirine-containing epoxides.

Other suitable diazirines include, for example, a diazirine-containing anhydride or NHS ester (or any related carbonyl electrophile). Further examples include diazirine-containing aldehydes, or diazirines that are covalently bound to aryl halides which may be used in a wide variety of coupling reactions known to those skilled in the art. Exemplary coupling reactions that may take place at aryl halides include, but are not limited to, aryl amination reactions and SNAr reactions.

Preferred are electron-rich aryl diazirines such as those in which a trifluoromethyl aryl diazirine is connected to a linker through the use of an ether or thioether or amine linkage, in such a way that the oxygen, sulfur or nitrogen atom is capable of donating electron density through the aromatic ring to stabilize a singlet carbene.

Substrates useful in the practice of the invention disclosed herein include, but are not limited to:
(1) Low-surface energy plastics containing aliphatic C—H bonds, (e.g. polyethylene, polypropylene, polyethylene terephthalate (PET)) and the like,
(2) Low-surface energy plastics that lack aliphatic C—H bonds, (e.g. fluoropolymers, polyketones, carbon fiber) and the like;
(3) Medium-surface energy plastics (e.g. nylon, poly(methylmethacrylate) (PMMA), polyurethanes, aromatic polyamides (aramids)) or the like;
(4) High-surface energy materials like wood or paper or brick or concrete or glass; (5) Composite materials like fiberglass;
(6) Metals and ceramics.

In one aspect of the invention disclosed herein, the polymer substrate being bonded is a low surface energy polymer (also referred to as a low-functionality polymer). As used herein, the term “low surface energy polymer” encompasses a polymer comprised principally of C—C and C—H (or C-halogen) bonds and which therefore lacks reactive functional groups such as, for example, carbonyl groups, hydroxyl groups, amines, amide or ester linkages.

Non-limiting examples of such polymers include polyethylene (including HDPE, LDPE, LLDPE, UHMWPE, and XLPE, as well as polyethylene copolymers and the like), polypropylene, and polyethylene terephthalate.

The term also encompasses silicone and fluoropolymers such as PTFE, FEP, PFA, and the like.

In another aspect of the invention the polymer is a polyethylene such as ultra-high molecular weight polyethylene (UHMWPE).

Polymeric substrates useful in the practice of the invention disclosed herein also include, for example, pre-made objects, films, powders, sheets, bare fibers, sized fibers, mesh and ribbons. Such materials can be further processed into shapes such as braided lines or ropes, woven and non-woven fabric, alternating orthogonal layers of unidirectional fibers, knitted fabric, laminated films and mesh or web constructs.

The methods disclosed herein provide a useful means of functionalizing the surfaces of commodity polymers, such that they may then engage in interaction or chemical reaction with secondary adhesives and resins. Such methods therefore facilitate the preparation of composite materials, including fiber reinforced polymer composites.

### Examples

### Example 1—Synthesis of a Diazirine-Grafted Poly(Amidoamine) (3a-A)

Commercially available poly(amidoamine) dendrimer (PAMAM, fifth generation, 28.8 kDa, with 128 amino termini) 5 wt % solution in methanol (2.4 mL, 103.8 mg PAMAM, 0.46 mmol NH2) was diluted to 0.5 wt % in methanol. 3-[4-(bromomethyl)phenyl]-3-(trifluoromethyl)-3H-diazirine (38.6 mg, 0.138 mmol) was added to the PAMAM/methanol solution, for a theoretical yield of 30% mol/mol diazirine/PAMAM NH2. The reaction was vigorously stirred for 32 h at room temperature in the dark and evaporated under vacuum to yield a pale-yellow viscous liquid (160 mg). ¹H NMR (300 MHz, CD30D) b 7.45, 7.19, 3.80, 3.34, 2.99-2.64, 2.59, 2.38. 19F NMR (283 MHz, CD30D) δ −66.75. IR (diamond-ATR): 3265, 3072, 2934, 2827, 1634, 1543, 1462, 1343, 1287, 1232, 1183, 1151, 1028, 938, 810 cm⁻¹.

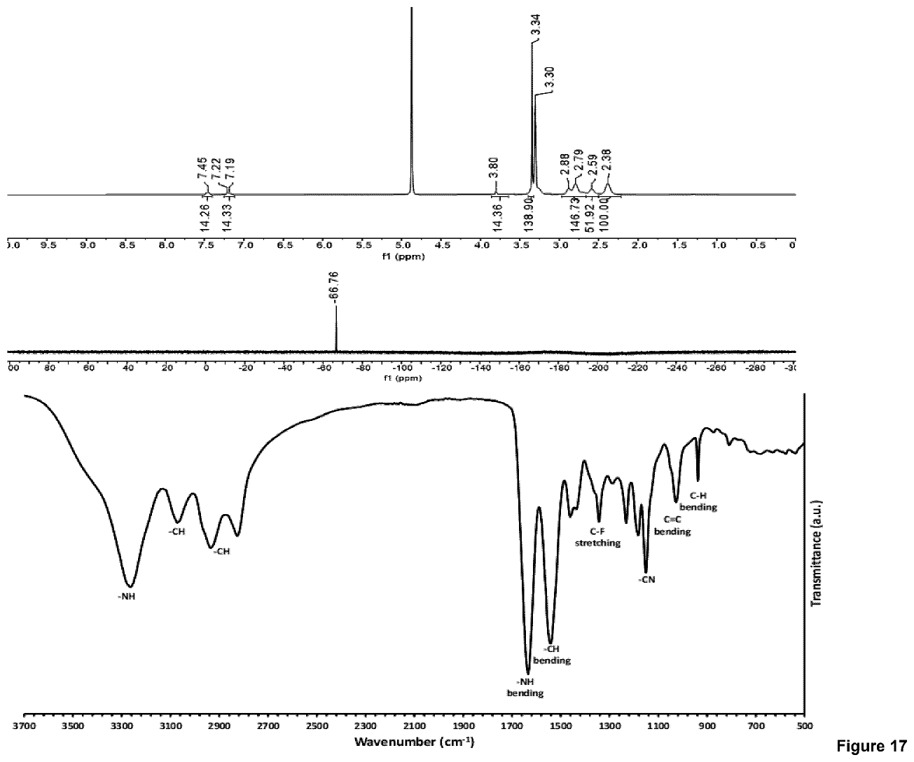

Integration of relevant signals in the ¹H NMR spectrum (FIG. 17) indicated a diazirine loading of approximately 28 mol %, which was consistent with the nominal 30 mol % loading intended for the addition reaction.

### Example 2—Synthesis of a Diazirine-Grafted Low-Molecular Weight Polyethylenimine (3a-B1)

PEI (800 g/mol, DP=19) (350 mg) was dissolved in 20 mL of methanol to provide a homogeneous solution after sonication. The solution was sparged with N2 for 2 minutes, after which 3-(4-(bromomethyl)phenyl)-3-(trifluoromethyl)-3H-diazirine (150 mg, 30 wt %) was added by dropwise addition to the reaction mixture. The mixture was stirred at room temperature for 72 hours in the dark. The solvent was removed on a rotary evaporator at room temperature, covered by aluminum foil, and the product was dried under vacuum to yield a pale-yellow viscous liquid. ¹H NMR (500 MHz, CD30D) b 7.65-7.49 (m), 7.42-7.23 (m), 4.01-3.73 (m), 3.04-2.48 (m). ¹³C NMR (126 MHz, CD30D) b 143.40, 130.81, 130.34, 130.25, 128.58, 128.50, 127.61, 123.62 (q, J=274.1 Hz), 59.77, 57.02, 56.68, 54.94, 54.86, 54.78, 52.39, 52.36, 52.27, 49.70, 48.05, 41.77, 41.72, 41.68, 41.58, 39.89, 29.46 (q, J=40.4 Hz). ¹⁹F NMR (471 MHz, CD30D) 5-66.74. IR (diamond-ATR): 3273, 2933, 2812, 1607, 1456, 1344, 1297, 1233, 1182, 1155, 1117, 1035, 938, 808 cm⁻¹.

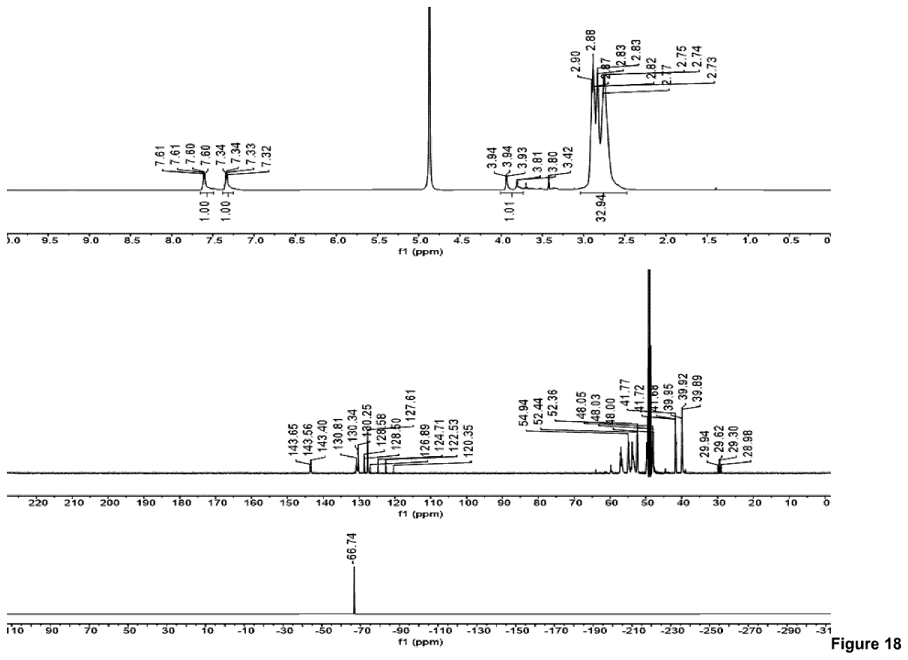

Integration of relevant signals in the ¹H NMR spectrum (FIG. 18) indicated a diazirine loading of approximately 6.1 mol %, which was consistent with the nominal 6.6 mol % loading intended for the addition reaction (i.e. 1.2 diazirine units per 800 g/mol polymer chain).

### Example 3—Synthesis of a Diazirine-Grafted Polyethylenimine with 30 wt % Diazirine Incorporation (3a-B2)

PEI (25,000 g/mol, DP=580) (350 mg) was dissolved in 20 mL of methanol to provide a homogeneous solution after sonication. The solution was sparged with N2 for 2 minutes, after which 3-(4-(bromomethyl)phenyl)-3-(trifluoromethyl)-3H-diazirine (150 mg, 30 wt %) was added by dropwise addition to the reaction mixture. The mixture was stirred at room temperature for 72 hours in the dark. The solvent was removed on a rotary evaporator at room temperature, covered by aluminum foil, and the product was dried under vacuum to yield a pale-yellow viscous liquid. ¹H NMR (500 MHz, CD30D) b 7.66-7.45 (m), 7.38-7.19 (m), 3.97-3.69 (m), 3.08-2.34 (m). ¹³C NMR (126 MHz, CD30D) b 143.37, 130.83, 130.24, 128.55, 127.59, 123.60 (q, J=273.9 Hz), 59.74, 56.69, 54.78, 53.72, 52.26, 52.11, 41.67, 41.62, 41.56, 39.81, 29.45 (q, J=41.2 Hz). ¹⁹F NMR (471 MHz, CD30D) δ −66.69.

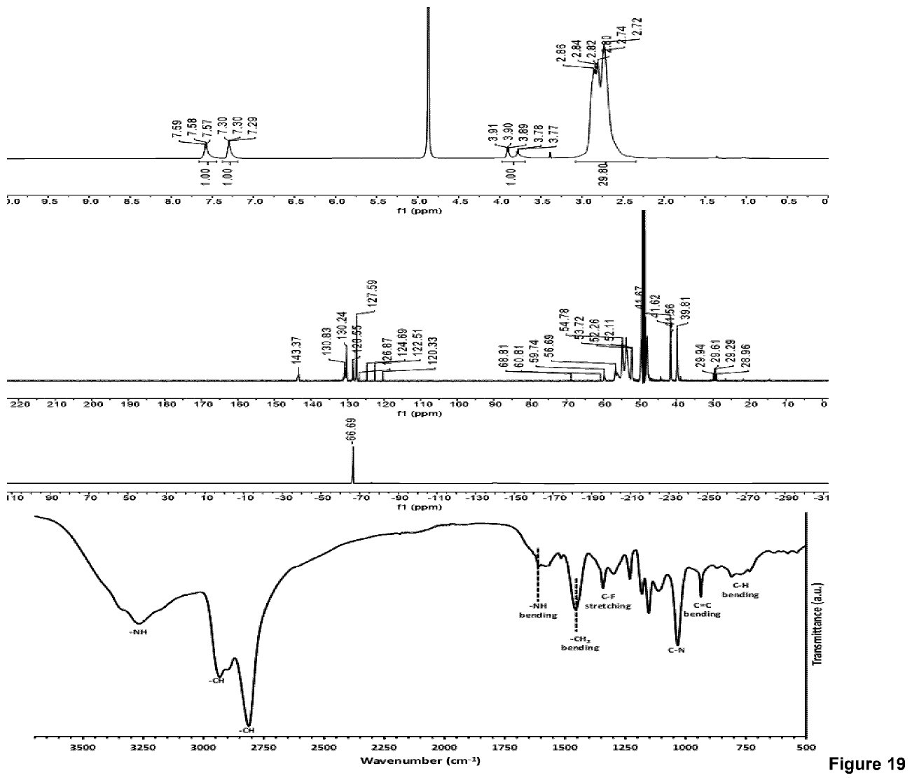

Integration of relevant signals in the ¹H NMR spectrum (FIG. 19) indicated a diazirine loading of approximately 6.7 mol %, which was consistent with the nominal 6.6 mol % loading intended for the addition reaction (i.e. 28.4 diazirine units per 25,000 g/mol polymer chain).

### Example 4—Synthesis of a Diazirine-Grafted Polyethylenimine with 20 wt % Diazirine Incorporation (3a-B3)

PEI (25,000 g/mol, DP=580) (400 mg) was dissolved in 20 mL of methanol to provide a homogeneous solution after sonication. The solution was sparged with N2 for 2 minutes, after which 3-(4-(bromomethyl)phenyl)-3-(trifluoromethyl)-3H-diazirine (100 mg, 20 wt %) was added by dropwise addition to the reaction mixture. The mixture was stirred at room temperature for 72 hours in the dark. The solvent was removed on a rotary evaporator at room temperature, covered by aluminum foil, and the product was dried under vacuum to yield a pale-yellow viscous liquid. ¹H NMR (500 MHz, CD30D) δ 7.63 (d, J=8.0 Hz), 7.47-7.20 (m), 4.04-3.76 (m), 3.11-2.49 (m). ¹³C NMR (126 MHz, CD30D) b 143.62, 130.82, 130.25, 128.56, 127.61, 123.62 (q, J=273.8 Hz), 55.08, 53.84, 52.52, 48.04, 41.79, 39.97, 29.44 (q, J=38.8 Hz). ¹⁹F NMR (471 MHz, CD30D) 5-66.68. IR (diamond-ATR): 3269, 2934, 2812, 1607, 1517, 1456, 1344, 1297, 1233, 1152, 1154, 1111, 1035, 938, 869, 764, 735 cm⁻¹.

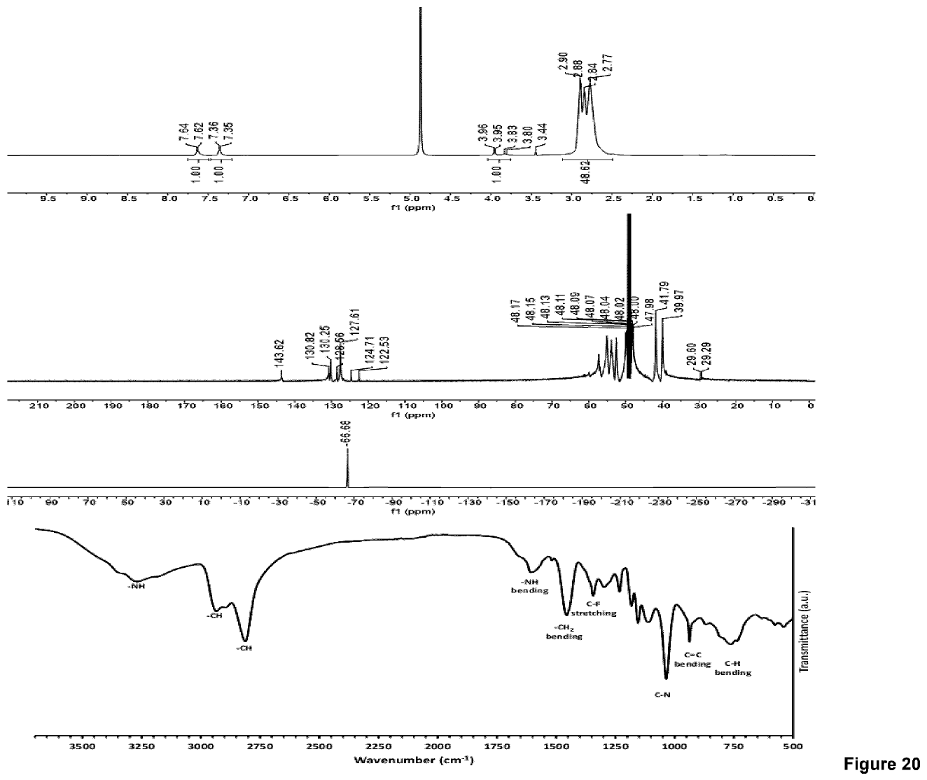

Integration of relevant signals in the ¹H NMR spectrum (FIG. 20) indicated a diazirine loading of approximately 4.1 mol %, which was consistent with the nominal 3.9 mol % loading intended for the addition reaction (i.e. 22.4 diazirine units per 25,000 g/mol polymer chain).

### Example 5—Synthesis of a Diazirine-Grafted Polyethylenimine with 10 wt % Diazirine Incorporation (3a-B4)

PEI (25,000 g/mol, DP=580) (450 mg) was dissolved in 20 mL of methanol to provide a homogeneous solution after sonication. The solution was sparged with N2 for 2 minutes, after which 3-(4-(bromomethyl)phenyl)-3-(trifluoromethyl)-3H-diazirine (50 mg, 10 wt %) was added by dropwise addition to the reaction mixture. The mixture was stirred at room temperature for 72 hours in the dark. The solvent was removed on a rotary evaporator at room temperature, covered by aluminum foil, and the product was dried under vacuum to yield a pale-yellow viscous liquid. ¹NMR (500 MHz, CD30D) b 7.82-7.53 (m), 7.40 (d, J=7.7 Hz), 3.93 (d, J=64.3 Hz), 3.12-2.43 (m). ¹³C NMR (126 MHz, CD30D) δ 143.62, 130.73, 130.24, 127.63, 123.64 (q, J=274.3 Hz), 57.47, 55.10, 53.91, 52.79, 48.49, 41.90, 40.14, 29.49 (q, J=39.2 Hz). ¹⁹F NMR (471 MHz, CD30D) δ −66.75. IR (diamond-ATR):3272, 2933, 2810, 1603, 1456, 1345, 1295, 1233, 1182, 1113, 1034, 938, 768 cm⁻¹.

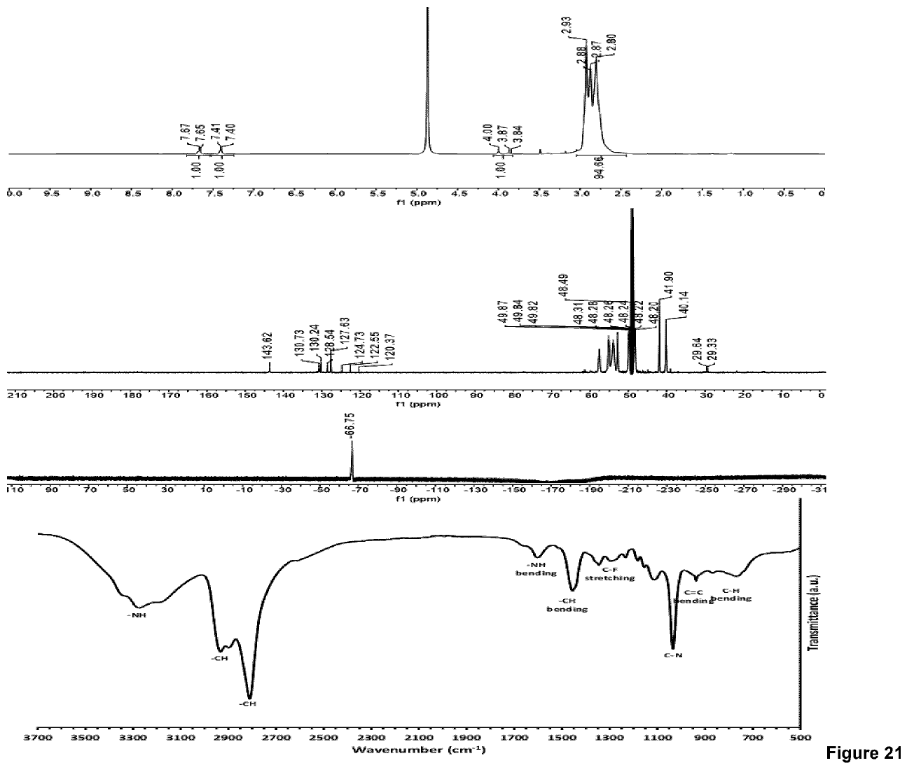

Integration of relevant signals in the ¹H NMR spectrum (FIG. 21) indicated a diazirine loading of approximately 2.1 mol %, which was consistent with the nominal 1.7 mol % loading intended for the addition reaction (i.e. 10.0 diazirine units per 25,000 g/mol polymer chain).

### Example 6—Reaction of Polymeric Diazirines with UHMWPE Fabric, Using Thermal Activation

To confirm reaction of the polymeric diazirines with low-functionality polymer surfaces, woven ultra-high molecular weight polyethylene (UHMWPE) fabric (75 g/m², 200 denier) was treated with methanolic solutions of polymeric diazines 3a-A, 3a-B1, 3a-B2, 3a-B3, and 3a-B4, using a nominal loading of 10, 5 and 1 weight percent, relative to the mass of fabric. To account for losses to the incubation pan, the added mass of polymer was increased by ca. 25%. Thus, actual loadings of 12.5 wt %, 6.5 wt %, and 1.25% of each polymer were used. A vehicle control sample was also prepared, which was treated identically to the other samples, but with 0 wt % added polymer. Additional control samples were prepared using 800 and 25,000 g/mol polyethylenimine (PEI) with no diazirine grafting.

The fabric was incubated in the methanolic polymer solutions for 30 minutes, after which the solvent was allowed to evaporate from the fabric. The resulting samples of polymer-impregnated woven UHMWPE were then incubated at 110° C. for 4 hours to activate the diazirine groups.

Following activation, the samples were each weighed to determine the total amount of impregnated polymer, and then were extracted three times with methanol to remove any reaction products that were not covalently linked to the fabric. After drying the treated fabrics, each sample was weighed again to determine the mass of reacted polymer that remained attached to the UHMWPE fiber.

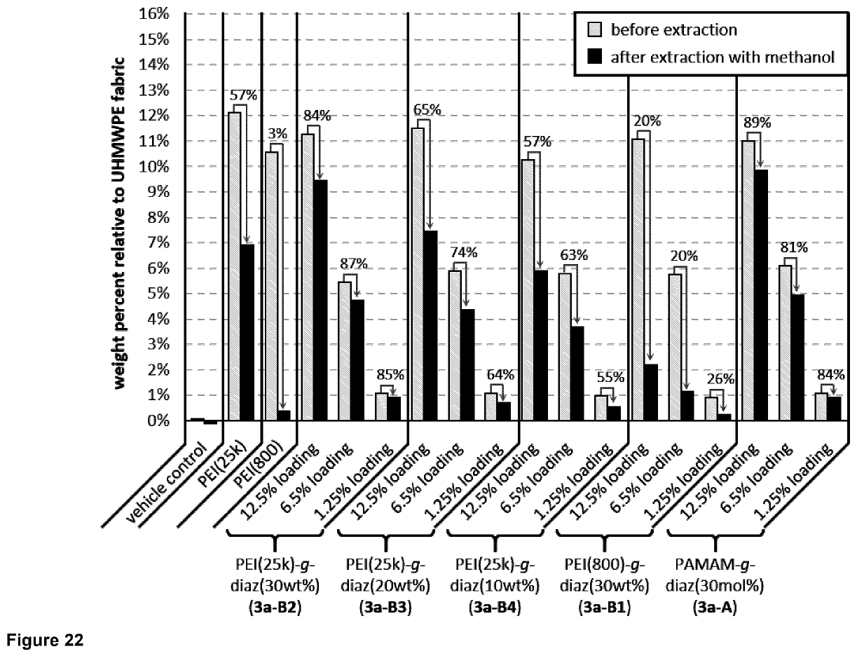

The data (FIG. 22) indicated that the soaking procedure was successful in impregnating approximately the desired amounts of poly(diazirine) into each fabric sample (i.e., ca. 10%, 5% or 1%; white bars in FIG. 22). Following extraction with methanol, an average of 85% of the reagent was retained in the PEI(25 k)-g-diazirine(30 wt %) samples (3a-B2) and the PAMAM-g-diazirine(30 mol %) samples (3a-A). The amount of retained reagent decreased with decreasing diazirine loading. For the PEI(25 k)-g-diazirine(20 wt %) samples (3a-B3) an average of 68% of the reagent was retained, and for the PEI(25 k)-g-diazirine(10 wt %) samples (3a-B4) an average of 59% was retained. However, this analysis was complicated by the known thermal decomposition of PEI, which leads to methanol-insoluble high-molecular weight aggregates. Thus, the PEI(25 k) control (containing no diazirine) also retained 57% of added mass following heat activation and methanol extraction. PEI(800)-g-diazirine(30 wt %) (3a-B1), which has fewer diazirine moieties per polymer chain, was retained at only 22%, relative to the initial impregnation. Consistent with this result, we found that only 3% of the initial impregnation mass was retained in the PEI(800) control sample.

Collectively, these data indicate that C—H insertions were occurring to link the polymer to the UHMWPE fiber surface, but that thermal background reactions for high-molecular weight polyamines were a complicating factor.

### Example 7—Reaction of Thermally Coated UHMWPE Fabrics with Epoxy Resin

To confirm that the amine groups in 3a-coated polyethylene remain chemically active and can react with applied adhesives and resins, we subjected the coated UHMWPE samples from Example 6 to reaction with a commercial epoxy reagent.

Each sample of treated fabric was first cut into three ca. 100 mg portions (to permit replicate analysis of epoxy loading) and then exposed to a methanolic solution of West System Epoxy 105, with no added hardener. The samples were incubated at 110° C. for 16 h to facilitate the targeted nucleophilic addition reaction between surface-bound amines and electrophilic epoxide groups present in the epoxy resin. Following the reaction, each sample was extracted 3 times with methanol and 3 times with dichloromethane to remove any unreacted epoxy resin.

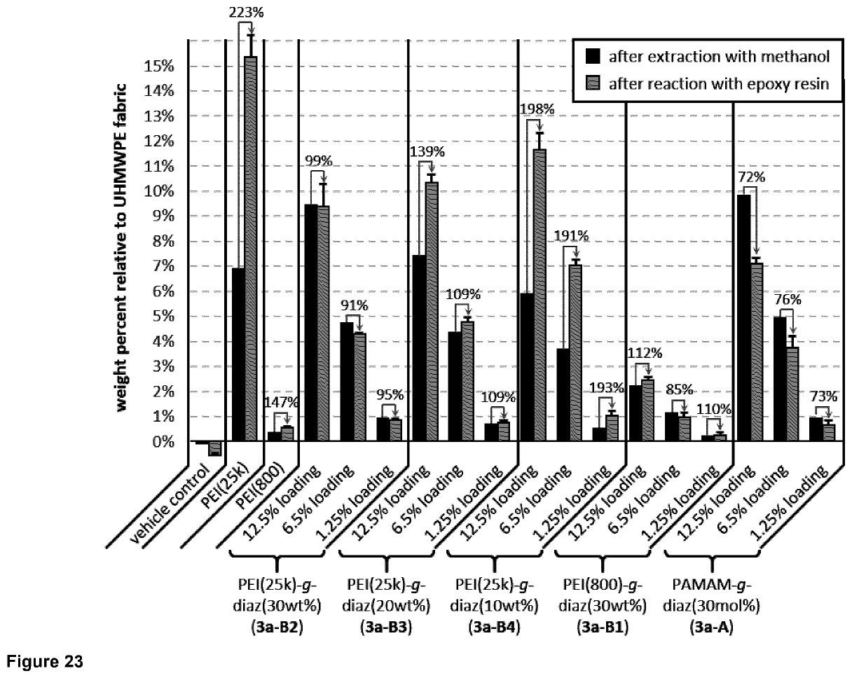

As expected, the vehicle control samples did not add any epoxy resin, and showed a small mass loss due to the extensive washing protocol removing soluble impurities from the UHMWPE fabric itself. By contrast, each of the samples that contained amines exhibited an increase in mass, resulting from epoxy that had reacted with the functionalized fiber surface. As shown in FIG. 23, the amount of reacted epoxy depended on the type of polyamine-diazirine conjugate used in the loading experiment, as well as the amount of conjugate that had been added in the preceding step. PEI(25 k)-g-diazirine(30 wt %) samples (3a-B2) gained an average amount of epoxy corresponding to 95% of the mass of added polyamine. In other words, for every milligram of polymer reagent added in the initial UHMWPE functionalization step, 0.95 mg of epoxy was bound to the surface in the subsequent nucleophilic addition step. The ratio increased for PEI(25 k) reagents that contained a higher level of free amines (i.e. those that had fewer nucleophilic positions blocked through the addition of diazirines). Thus, the PEI(25 k)-g-diazirine(20 wt %) samples (3a-B3) gained an average of 119% epoxy, relative to the amount of polyamine, while the PEI(25 k)-g-diazirine(10 wt %) samples (3a-B4) gained an average of 194%. Consistent with this trend, the PEI(25 k) control sample, which contained insoluble polyamine aggregates resulting from thermal decomposition, accumulated 223% additional mass, relative to the amount of amine-containing material on the surface.

The other polymer coatings were also successful at reacting with epoxy resin, but each netted somewhat less total epoxy than the PEI(25 k) coatings—either due to a less-effective reaction between the surface-bound polyamine and the epoxy resin, or due to lower loading in the initial fiber functionalization step. PEI(800)-g-diazirine(30 wt %) (3a-B1) experienced a similar relative increase in mass (1.02 mg added epoxy for every mg of surface-bound polyamine) to the analogously functionalized PEI(25 k)-g-diazirine(30 wt %) (3a-B2; 0.95 mg added epoxy per mg of polyamine)—but because much less of the smaller-molecular weight polymer reagent was attached to the surface in the initial immobilization step, the total amount of bound epoxy was much lower. By contrast, PAMAM-g-diazirine(30 wt %) (3a-A), for which similar loading levels to 3a-B2 had been observed in the immobilization step, was evidently less effective at reacting with available epoxy electrophile; an average of only 0.74 mg of epoxy was added for every mg of surface-bound polymer 3a-A.

The above data illustrate compelling structure-function relationships for polyamine-diazirine conjugates. However, the results are complicated by the non-specific thermal degradation observed for PEI (and therefore for the PEI-diazirine conjugates as well), which resulted in the highest epoxy loading occurring for the PEI(25 k) control sample.

### Example 8—Reaction of Polymeric Diazirines with UHMWPE Fabric, Using Photochemical Activation

To confirm reaction of the polymeric diazirines with low-functionality polymer surfaces under conditions where thermal decomposition of the polymer backbone was not a complicating factor, the experiments described in Example 6 were repeated, this time irradiating the polymer-adsorbed samples with 365 nm light instead of incubating them in an oven. The PAMAM-g-diazirine reagent (3a-A) was not used in this Example, since the experiments in Example 7 had shown that this conjugate was less successful at engaging in nucleophilic attack with epoxy resin.

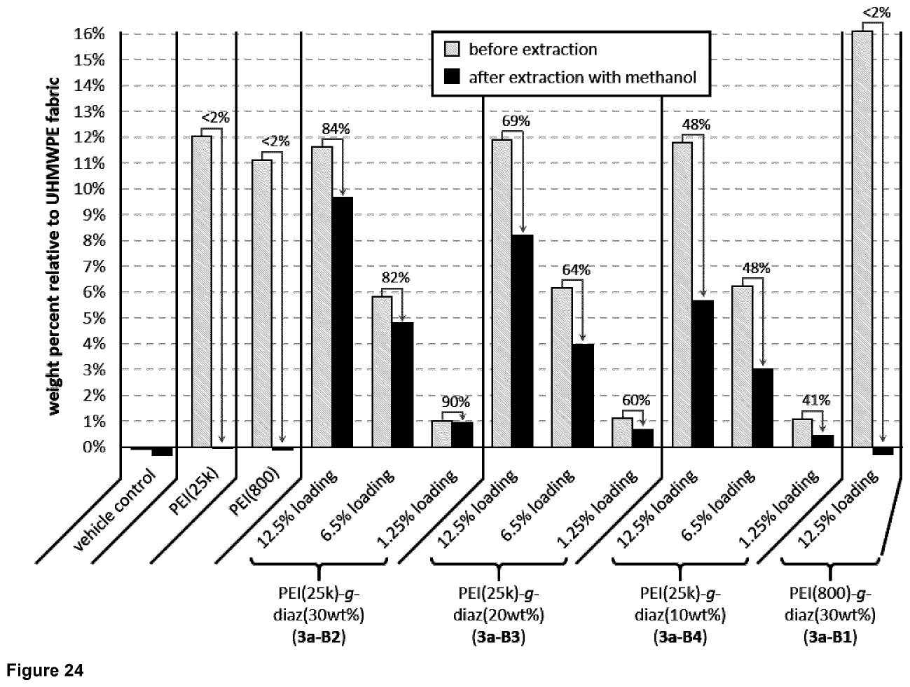

The protocol in this Example resulted in much cleaner surface functionalization, relative to the results from Example 6. As shown in FIG. 24, both polyamine control samples-PEI(25 k) and PEI(800)-showed no mass increase following washing, indicating that no insoluble polyamine aggregates were produced, and there was now a clear relationship between the degree of surface immobilization and the amount of diazirine present on the polyamine-diazirine conjugate. PEI(25 k)-g-diazirine(30 wt %) (3a-B2) was retained at an average level of 85%, while PEI(25 k)-g-diazirine(20 wt %) (3a-B3) was retained at an average level of 64%, and PEI(25 k)-g-diazirine(10 wt %) (3a-B4) was retained at an average level of 46%. Interestingly, the smaller-molecular weight PEI(800)-g-diazirine(30 wt %) conjugate (3a-B1) was not retained at all.

The above data are consistent with the average number of diazirines present per polymer molecule, and the known reactivity of the trifluoromethyl phenyl diazirine motif. It is known in the art that the parent trifluoromethyl phenyl diazirine adds to cyclohexane (a molecular model for polyethylene) in yields of only 35% following photochemical activation, and 15% following thermal activation. Much of the remaining mass balance is ketone that results from reaction of the intermediate triplet carbene with molecular oxygen. Given the lack of selectivity for C—H insertion over side reactions (as well as the fact that generated carbenes can react with the polymer reagent itself, at least as readily as they can with the UHMWPE fiber), it is reasonable to expect that in order to covalently link a polyamine to an UHMWPE fiber, one may require several diazirine units to be present on each polymer chain. Otherwise the thermal or photochemical curing steps will result mostly in ketones or self-reaction products, and will not productively attach the diazirine-containing polymer to the surface.

Polymer conjugate 3a-B1 (PEI(800)-g-diazirine(30 wt %)) incorporates an average of only 1.2 diazirine units per polymer chain. As such, it is unsurprising that it does not bind efficiently to the UHMWPE surface. By contrast, polymer conjugates 3a-B4, 3a-B3, and 3a-B2 incorporate 10, 22, and 38 diazirines per polymer chain, respectively. It therefore makes intuitive sense that these three diazirine conjugates should function better in the immobilization step, and that the level of retained polymer after washing should increase as one moves to higher diazirine loadings.

In addition to supporting a cleaner relationship between diazirine loading and immobilization, the UV-activated samples in this Example were also physically cleaner than the thermally activated samples from Example 6, since they did not suffer from the yellowing that results from thermally promoted PEI degradation.

### Example 9—Reaction of Photochemically Coated UHMWPE Fabrics with Epoxy Resin

The epoxy reaction of surface-bound amines described in Example 7 was repeated for the UV-activated samples described in Example 8.

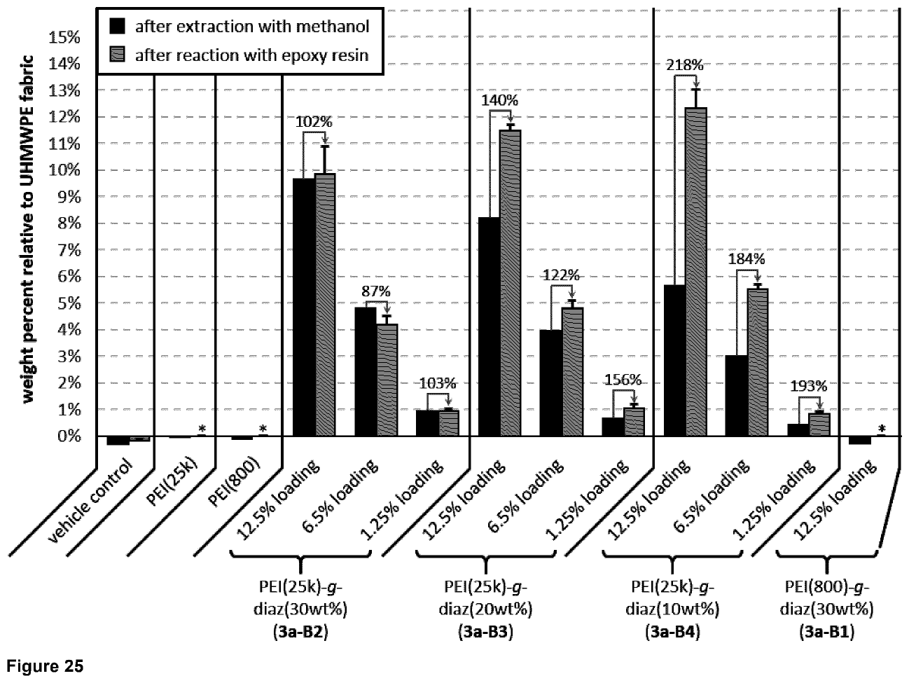

As shown in FIG. 25, a clear increase in the amount of reacted epoxy was observed as the number of available amine groups was increased across the series 3a-B2→3a-B3→3a-B4. Samples treated with PEI(25 k)-g-diazirine(30 wt %) (3a-B2) gained an average of 0.98 mg epoxy for each mg of polyamine reagent present on the surface of the fabric, while samples treated with PEI(25 k)-g-diazirine(20 wt %) (3a-B3) gained an average of 1.39 mg epoxy for each mg of surface-bound polyamine. Most impressively, samples treated with PEI(25 k)-g-diazirine(10 wt %) (3a-B4) gained an average of 1.98 mg epoxy for every mg of polyamine. As observed in Example 7, the vehicle control samples did not add any epoxy, and suffered a small mass loss due to the extensive solvent extraction process removing soluble impurities trapped within the commercial UHMWPE fabric.

The above data reveal a trade-off between effective surface functionalization and effective nucleophilic addition reaction to the epoxy resin. Decreasing the number of diazirine units on the polymer chain (from 3a-B2 to 3a-B3 to 3a-B4) reduces the yield in the immobilization step, since fewer carbenes are generated that can participate in C—H insertion reactions. Polyamine-diazirine conjugate 3a-B4 therefore had the lowest percent retention of polyamine among the three PEI(25 k)-diazirine reagents, while the PEI(25 k) control sample did not retain any surface-bound reagent following UV activation. At the same time, lowering the diazirine loading effectively increases the number of amine groups that are available for nucleophilic addition with the electrophilic epoxy resin. Higher relative yields were therefore observed for 3a-B4 over 3a-B2, in the epoxy reaction. Interestingly, although PEI(25 k)-g-diazirine(10 wt %) (3a-B4) performed the worst among the three PEI(25 k)-diazirine conjugates in the immobilization step, it actually bound the largest amount of total epoxy-up to 12.32 wt % relative to the mass of the original UHMWPE fabric.

### Example 10—Surface Characterization by FT-IR for Polyamine-Diazirine Treated UHMWPE Fabrics

FT-IR spectra were recorded for representative fabrics treated with polyamine-diazirine conjugates 3a, following the surface-conjugation methods described in Examples 6 and 8, and the epoxy reaction steps described in Examples 7 and 9. In each case, spectra were recorded before and after reaction with epoxy resin, so that any changes could be documented.

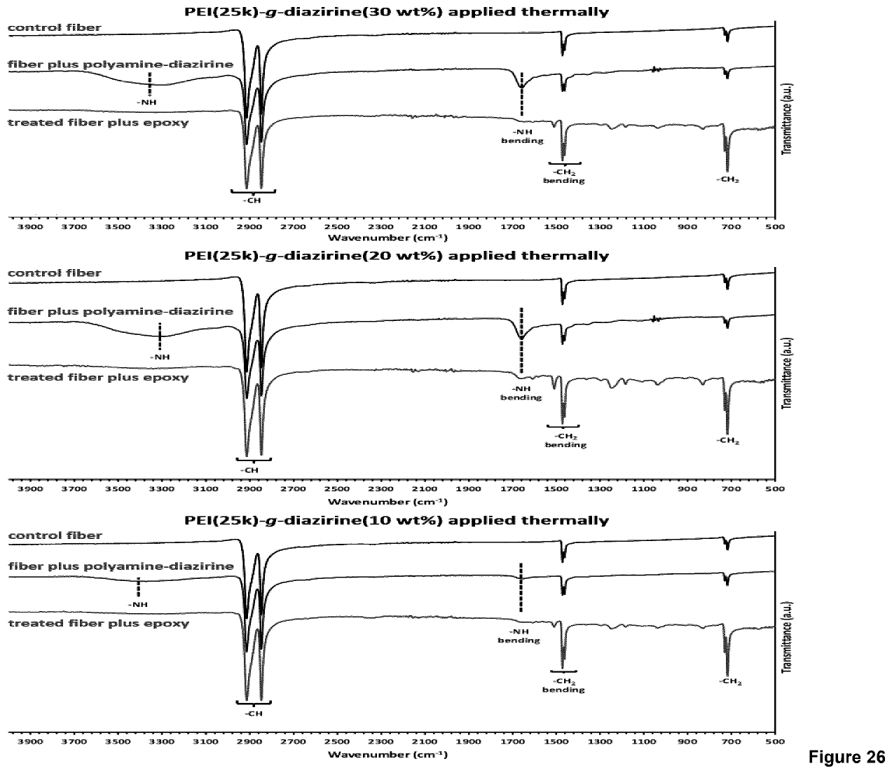

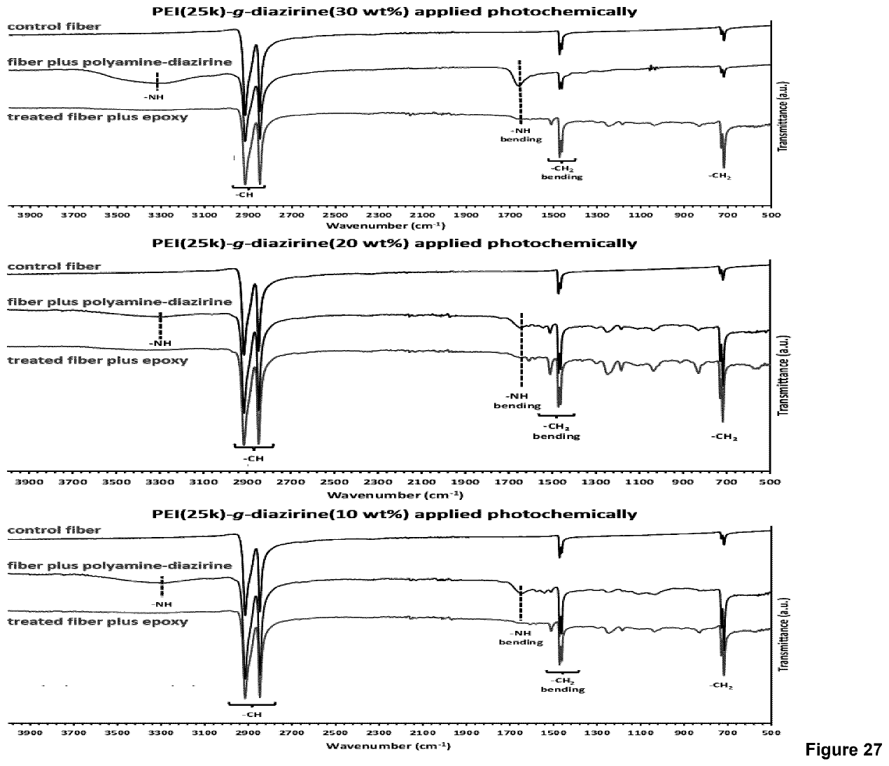

For each set of samples (FIGS. 26 and 27), the appearance of peaks corresponding to N—H stretching modes (ca. 3350 cm⁻¹) and N—H bending modes (ca. 1660 cm⁻¹) following application of the conjugate confirmed that the surface of the UHMPE fiber had been successfully coated with amine groups. These signals greatly diminished when the polyamine-coated UHMWPE samples were allowed to react with epoxy resin, providing additional evidence that successful nucleophilic addition had taken place. For any given polyamine-diazirine conjugate, no significant differences in the IR data were apparent when the activation mode was changed from thermal to photochemical excitation.

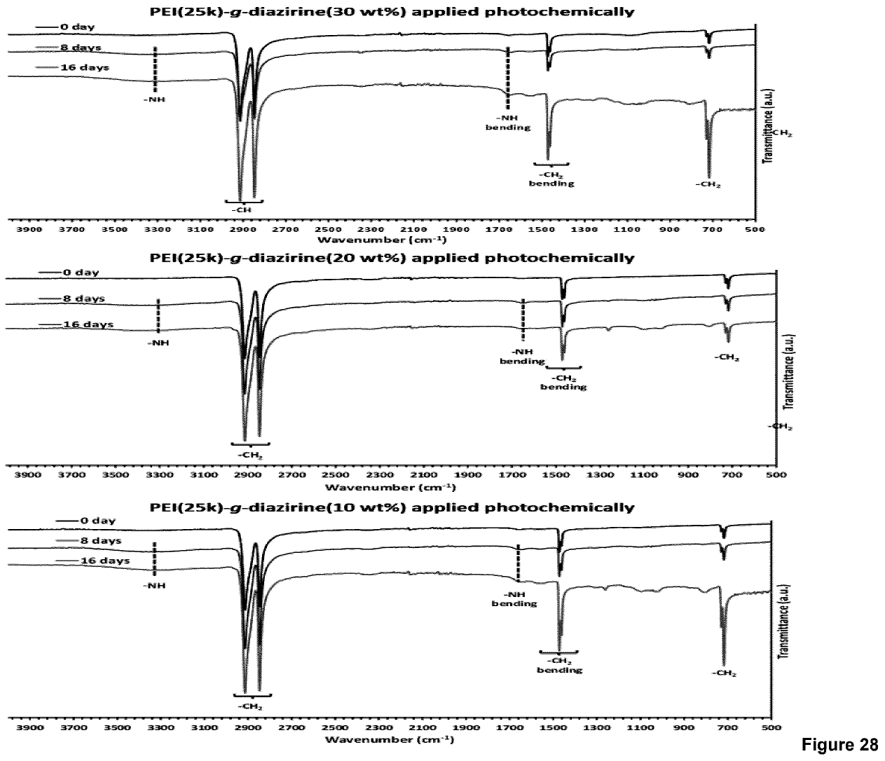

Representative samples were monitored by FT-IR over a period of 16 days. As shown in FIG. 28, the amine signals persisted over this time, indicating that UHMWPE fabric treated with polyamine-diazirine conjugates exhibits reasonable shelf stability and is not excessively sensitive to surface oxidation.

### Example 11—Polarity Assessment for Polyamine-Diazirine Treated UHMWPE Fabrics

An extensive series of water contact angle measurements were carried out for representative fabrics treated with polyamine-diazirine conjugates 3a-B2, 3a-B3, 3a-B4, and 3a-B1 following the surface-conjugation methods described in Examples 6 and 8, and the epoxy reaction steps described in Examples 7 and 9. In each case, spectra were recorded before and after reaction with epoxy resin, so that any changes could be documented.

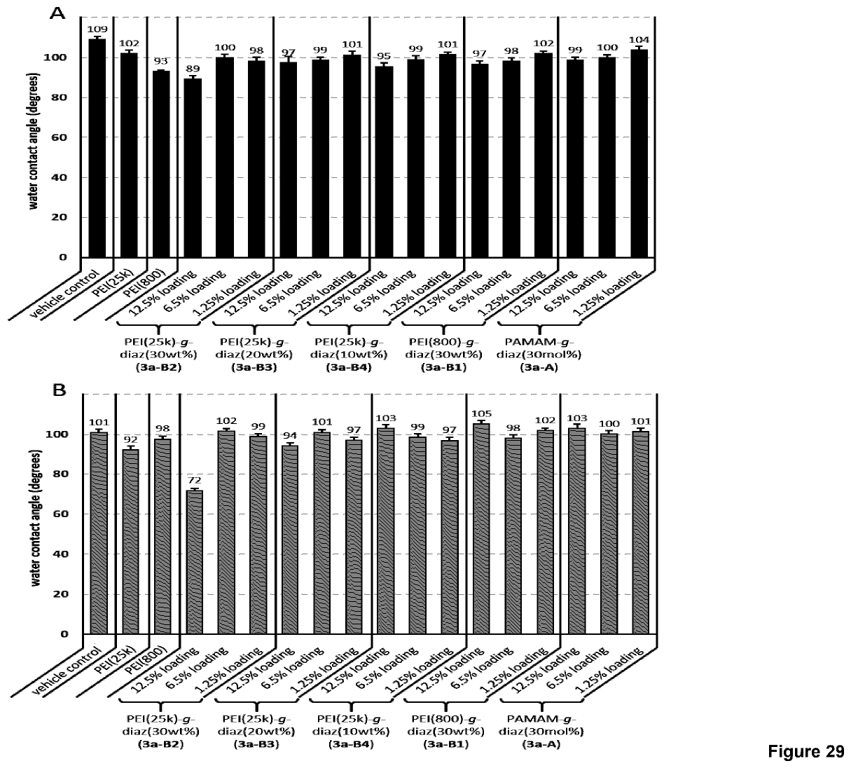

Substantial differences in surface contact angle were observed depending on the activation method used. When thermal activation was employed to attach the polyamine-diazirine conjugate to the polymer surfaces, the measured contact angle never dropped below 90°, except in the case of the highest loading (12.5 wt %) of conjugate 3a-B2 (FIG. 29). For all other samples, only very modest decreases in hydrophobicity were observed, relative to that of the vehicle control sample. Reaction of the thermally applied polyamine surfaces with epoxy resin did little to change this, and once again only in the case of the highest loading of conjugate 3a-B2 did we observe a significant decrease in contact angle.

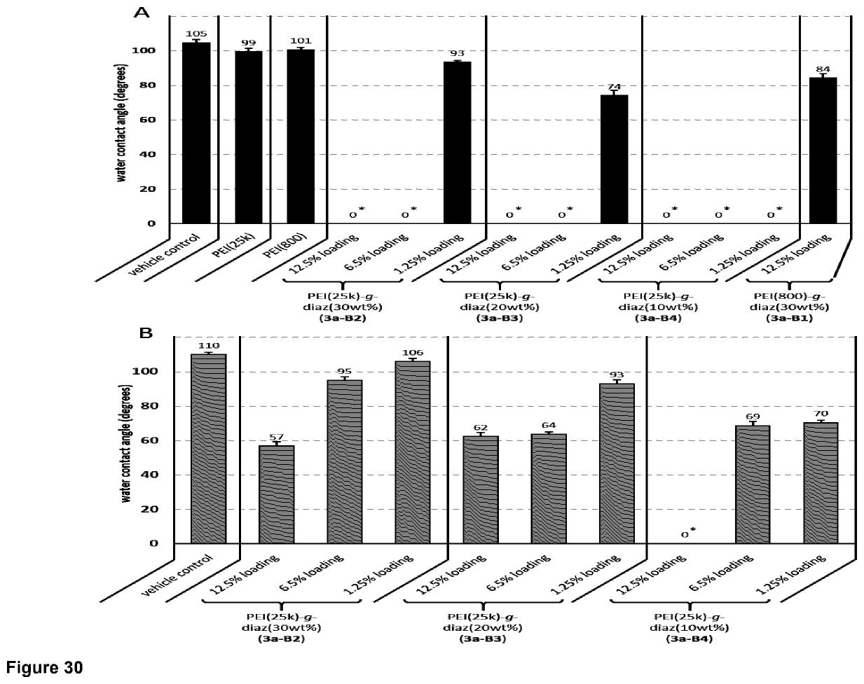

By contrast, photochemical application of the polymeric diazirine dramatically improved hydrophilicity of the polymer fiber, to the point that in many cases (high and medium loadings of conjugates 3a-B2 and 3a-B3, plus all three loading levels of conjugate 3a-B4) the water droplet was immediately drawn into the fiber, such that a contact angle of zero degrees was recorded for the experiment (FIG. 30). This effect was found to be highly reproducible. For each of the seven sample types in FIG. 30 in which a contact angle of 0° was recorded, all ten water droplets applied to the treated surface exhibited identical behavior. When these highly polar surfaces were reacted with epoxy resin, the hydrophobicity increased in a dose-dependent fashion, such that the samples that had been treated with less polyamine-diazirine conjugate recovered to a surface energy that was closer to that of the vehicle control (FIG. 30). Samples that had been treated with a higher loading of the polyamine-diazirine conjugate retained a low contact angle following epoxy treatment, and in one case (a 12.5% loading of conjugate 3a-B4) remained sufficiently polar that the applied water droplet was drawn into the fiber faster than a contact angle could be recorded. Once again this behavior was found to be reproducible, with 10/10 droplets applied to different regions of the treated fabric surface exhibiting identical behavior.

These data indicate that polyamine-diazirine conjugates, when photochemically applied, are capable of introducing surprising levels of hydrophobicity, even to low-surface energy materials. This indicates that such agents will have utility as primers useful for activating surfaces toward the application of traditional adhesives, many of which benefit from hydrogen bonding with polar surfaces. Moreover, in cases where the bulk adhesive is capable of reacting with surface-bound amines, even stronger adhesion may be predicted.

### Example 12—Use of Polymeric Diazirine as a Single-Component Adhesive

To confirm the efficacy of a representative polymeric diazirine as a single-component adhesive for low surface energy materials, polyamine-diazirine conjugate 3a-B4 (ca. 10 mg) was deposited from a 10 wt % solution in acetone onto a 1″×1″ region of a piece of transparent polyethylene film. After evaporation of the acetone, a second piece of polyethylene film was placed over top of the first and pressed lightly into place, in such a way that the unglued sections were oriented away from one another.

The 1″×1″ overlap region (containing 3a-B4 sandwiched between two layers of transparent polyethylene) was irradiated with 365 nm light for 30 seconds, using a high-power UV curing LED spotlight (ThorLabs CS20K2 handheld light source equipped with a collimation adaptor; 880 mW minimum power). After curing, the bonded sample was challenged by pulling the two unglued ends of polyethylene film in opposite directions. Strong bonding was observed.

The experiment was repeated using shorter curing times (5 seconds, 10 seconds and 20 seconds) as well as longer curing times (1 minute). Shorter curing led to noticeably weaker bonds, while no significant difference was noted between 30 seconds and 1 minute curing times. Control samples with no added polymeric diazirine gave no bonding.

### Example 13—Use of Polymeric Diazirine as a Primer, in Combination with Bulk Cyanoacrylate Adhesive

To confirm the efficacy of a representative polymeric diazirine as a primer for use in activating low-functionality surfaces toward bonding using traditional adhesives, polyamine-diazirine conjugate 3a-B4 (1 mg) was deposited from 10 μL of a 10 wt % solution in acetone onto a 1″×1″ region of a strip of polyethylene terephthalate (PET) film. An identical 1 mg deposit was made onto a second strip of PET. The two treated strips of plastic were left in a fumehood for three minutes to ensure evaporation of the acetone dispersant. Following evaporation, the 1″×1″ treated region of each PET strip was photocured by irradiating with 365 nm light for 30 seconds, using a high-power UV curing LED spotlight (ThorLabs CS20K2 handheld light source equipped with a collimation adaptor; 880 mW minimum power). One drop of commercial cyanoacrylate adhesive (Krazy®-glue; ca. 15 mg) was then applied to the 1″×1″ treated region of each PET strip. The cyanoacrylate was spread over the 1″×1″ treatment region using a small paintbrush, after which the two strips were pressed together such that the two treated areas comprised a single 1″×1″ overlap region, with the trailing ends of each strip pointing outward from the PET-polyamine-cyanoacrylate-polyamine-PET sandwich in opposite directions.

The resulting lap-shear sandwich was held together for 3 minutes (using binder clamps) to allow the cyanoacrylate to cure. After curing, the bonded sample was challenged by pulling the two unglued ends of the PET film in opposite directions. Strong bonding was observed in samples prepared as described above. No significant bonding was observed for control samples in which two pieces of untreated PET were pressed together for 3 minutes with cyanoacrylate adhesive.

Additional experiments were conducted using PTFE samples, as well as Vectra polymer samples. Once again, strong bonding was observed samples in which 3a-B4 was added as a primer, but not for samples in which the polyamine-diazirine was left out.

### Example 14—Use of Polymeric Diazirine as a Primer, in Combination with Bulk Epoxy Adhesive

To confirm the efficacy of a representative polymeric diazirine as a primer for use in activating low-functionality surfaces toward bonding with epoxy, pairs of 4″×1″×¼″ bars of ultra-high molecular weight polyethylene (UHMWPE, Röchling Engineering Plastics) were treated with commercial epoxy/hardener mixture, polyethylenimine (PEI), or PEI(25 k)-g-diazirine(30 wt %) (3a-B2) and the strength of adhesive bonding was determined in accordance with ASTM D1002. Prior to adding polyamines or adhesives, the edges of each polyethylene bar were scraped to smoothness using a utility knife and wiped with Kimwipes to remove dust/plastic particles. Additional experimental details are provided below:

### 14.1 Preparation of Epoxy/Hardener Mixtures:

Mixtures of epoxy resin (West System 105) and hardener (West System 205) were freshly prepared, using the automatic dispensing system sold alongside the commercial resin and hardener reagents. One pump of Epoxy Resin 105 (20.923±0.086 g, n=5) and one pump of Hardener 205 (3.904±0.062, n=5) were combined, resulting in a average mass ratio of 5.4:1. The epoxy/hardener mixture was stirred for 30 seconds at room temperature before deposition onto the sample bars.

14.2 Preparation of Control Samples from Primer-Treated Polyethylene Bars:

Polyamine-diazirine conjugate 3a-B2 was dissolved in methanol to prepare a 45 mg/mL solution. This was used to deposit the diazirine reagent onto the surface of the 1″×0.5″ overlap zone of the lap-shear sample using a micropipette (22 μL for 1 mg of 3a-B2, 11 μL for 0.5 mg of 3a-B2). The solvent was allowed to evaporate, and then pairs of bars were left uncovered in an oven for 6.5 h at 114-130° C. After cooling, each pair of bars was placed together using binder clamps and returned to the oven. After 16.5 h at 115-119° C., the samples were removed from the oven, cooled to room temperature, and challenged in a lap-shear experiment. 14.3 Preparation of adhered 3a-B2-Epoxy-Epoxy-3a-B2 control samples: Polyamine-diazirine conjugate 3a-B2 was dissolved in methanol to prepare a 45 mg/mL solution. This was used to deposit the diazirine reagent onto the surface of the 1″×0.5″ overlap zone of the lap-shear sample using a micropipette. The solvent was allowed to evaporate, and then pairs of bars were left uncovered in oven for 6.5 h at 114-130° C. After cooling, 50 mg of Epoxy 105 resin was deposited on each bar and then heat cured for 15 h at 115-125° C. The epoxy-treated area was then dipped in methanol for 1 min and drip-washed with methanol for another 2 min to remove unreacted epoxy resin. After solvent evaporation, each bar was reweighed, revealing that around 15 mg of epoxy resin was left on the 1″×0.5″ overlap region. Next, each pair of bars was placed together using binder clamps and returned to the oven for a third cycle of heating. After 18 h at 111-119° C., the samples were removed from the oven, cooled to room temperature, and challenged in a lap-shear experiment.

14.4 Preparation of Adhered 3a-B2-Epoxy-3a-B2 Control Samples:

Polyamine-diazirine conjugate 3a-B2 was dissolved in methanol to prepare a 45 mg/mL solution. This was used to deposit the diazirine reagent onto the surface of the 1″×0.5″ overlap zone of the lap-shear sample using a micropipette (22 μL for 1 mg of 3a-B2, 11 μL for 0.5 mg of 3a-B2). The solvent was allowed to evaporate, and then pairs of bars were left uncovered in an oven for 6.5 h at 114-130° C. After cooling, 5 or 10 mg of Epoxy 105 resin was deposited on only one bar of each pair. Next, one bar with epoxy (5 or 10 mg) and one bar without epoxy were held together with binder clamps and placed into an oven for a second round of thermal curing. After 16.5 h at 115-119° C., the samples were removed from the oven, cooled to room temperature, and challenged in a lap-shear experiment.

14.5 Preparation of Adhered PEI(25 k)-Epoxy/Hardener-PEI(25 k) Control Samples:

PEI was dissolved in methanol to prepare a 52 mg/mL solution. This was used to deposit the polyamine (containing no diazirine groups) onto the surface of the 1″×0.5″ overlap zone of the lap-shear sample using a micropipette (19 μL for 1 mg of PEI, 9.5 μL for 0.5 mg of PEI). The solvent was allowed to evaporate, and then pairs of bars were left uncovered in oven for 6.5 h at 130-140° C. After cooling, 10 mg of epoxy/hardener mixture was deposited on only one bar of each pair. Next, one bar with epoxy/hardener and one bar without epoxy/hardener were held together with binder clamps and placed into an oven for a second round of thermal curing. After 21 h at 115-120° C., the samples were removed from the oven, cooled to room temperature, and challenged in a lap-shear experiment.

14.6 Preparation of Adhered 3a-B2-Epoxy/Hardener-3a-B2 Samples:

Polyamine-diazirine conjugate 3a-B2 was dissolved in methanol to prepare a 31 mg/mL solution. This was used to deposit the diazirine reagent onto the surface of the 1″×0.5″ overlap zone of the lap-shear sample using a micropipette (32 μL for 1 mg of 3a-B2, 16 μL for 0.5 mg of 3a-B2). The solvent was allowed to evaporate, and then pairs of bars were left uncovered in oven for 6.5 h at 130-140° C. After cooling, 10 mg of epoxy/hardener mixture was deposited on only one bar of each pair. Next, one bar with epoxy/hardener and one bar without epoxy/hardener were held together with binder clamps and placed into an oven for a second round of thermal curing. After 21 h at 115-120° C., the samples were removed from the oven, cooled to room temperature, and challenged in a lap-shear experiment.

14.7 Preparation of Adhered 3a-B2-Epoxy-Epoxy/Hardener-Epoxy-3a-B2 Samples:

Polyamine-diazirine conjugate 3a-B2 was dissolved in methanol to prepare a 38.6 mg/mL solution. This was used to deposit the diazirine reagent onto the surface of the 1″×0.5″ overlap zone of the lap-shear sample using a micropipette (26 μL for 1 mg of 3a-B2, 13 μL for 0.5 mg of 3a-B2). The solvent was allowed to evaporate, and then pairs of bars were left uncovered in oven for 6.5 h at 125-135° C. After cooling, 50 mg of Epoxy 105 resin was deposited on each bar and then heat cured for 10 h at 111-116° C. The epoxy-treated area was then dipped in methanol for 2 min and drip-washed with methanol for another 2 min to remove unreacted epoxy resin. After solvent evaporation, each bar was reweighed, revealing that around 14 mg of epoxy resin was left on the 1″×0.5″ overlap region. After cooling, 10 mg of epoxy/hardener mixture was deposited on only one bar of each pair. Next, one bar with epoxy/hardener and one bar without epoxy/hardener were held together with binder clamps and placed into an oven for a third round of thermal curing. After 19 h at 108-115° C., the samples were removed from the oven, cooled to room temperature, and challenged in a lap-shear experiment.

### 14.8 Preparation of Adhered Positive Samples:

Positive controls were prepared by adding ca. 10 mg epoxy/hardener mixture (prepared as described above) directly to the overlap zone of aluminum-aluminum and PMMA-PMMA lap-shear samples, with no solvent. The samples were held together with binder clamps and placed into an oven for 21 h at 115-120° C., then cooled to room temperature and challenged in a lap-shear experiment.

### 14.9 Preparation of Adhered Negative Control (UHMWPE-Epoxy/Hardener-UHMWPE) Samples:

Negative (vehicle) controls were prepared in an identical manner, except that ca. 10 mg epoxy/hardener mixture (prepared as described above) was added directly onto the overlap region of UHMWPE bars. The samples were held together with binder clamps and placed into an oven for 21 h at 115-120° C., then cooled to room temperature and challenged in a lap-shear experiment.

### 14.10: Measurement of Lap-Shear Samples:

The two trailing ends of the adhered UHMWPE samples (as well as aluminum and PMMA control samples) prepared as described above were clamped in a universal testing system (Instron, Series 5969) and pulled apart at a rate of 3 mm/min until breakage of the bond, according to ASTM D1002. The maximum force was recorded for each specimen. Adhesion strength (MPa) was calculated as the amount of shear force (in Newtons) needed to break the sample, divided by the overlap area (in mm²).

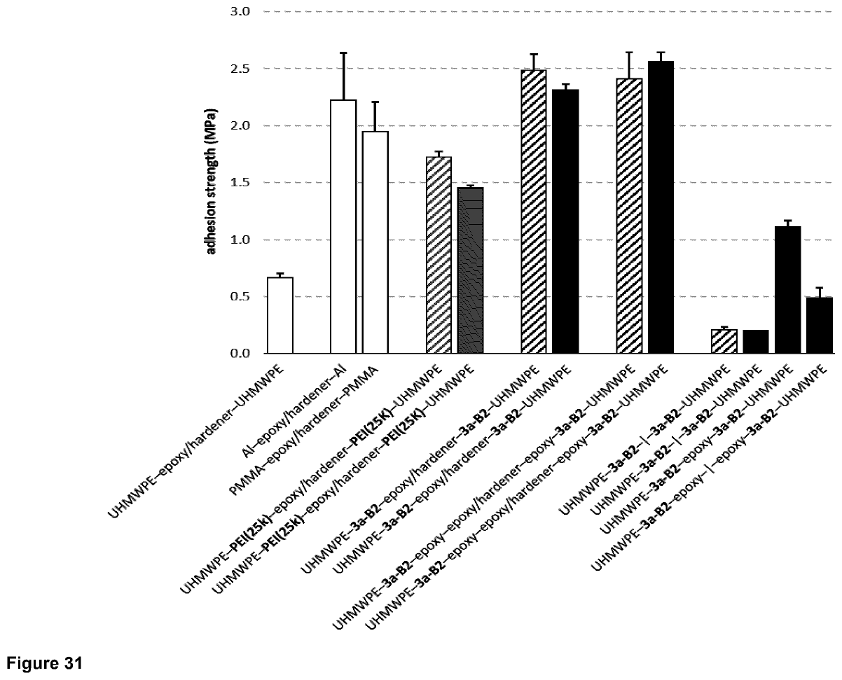

The results of lap-shear testing (FIG. 31) indicated that UHMWPE bars that had been treated with 3a-B2 (with or without an epoxy sizing step) prior to application of the epoxy/hardener mixture showed significantly increased adhesion relative to the negative control samples. In fact the adhesion strength exceeded that of the positive controls, reaching ca. 2.5 MPa.

Only modest differences in adhesion strength were observed when the amount of applied polyazirine-diazirine conjugate was changed from 0.5 to 1.0 mg per UHMWPE bar, and no significant differences were observed when the additional epoxy sizing step was employed. In contrast to the negative control samples, which gave better adhesion with larger amounts of applied adhesant, samples treated with 3a-B2 prior to addition of the epoxy/hardener layer showed no differences in adhesion when the quantity of adhesant was varied. This consistency of adhesion suggests that failure is occurring—at least partially—within the epoxy matrix, rather than at the interface.

Control samples made using thermally applied PEI (containing no diazirine groups) in place of 3a-B2 also showed increased adhesion relative to negative control samples, but displayed significantly less adhesion than those samples that had been prepared with the diazirine-containing polymer. These data indicate that even under thermal activation conditions the diazirine groups are still playing an important role in facilitating bonding to the surface of the UHMWPE.

Only minimal adhesion (i.e. less than in the negative control) was observed when the epoxy/hardener mixture was left out, and the two 3a-B2-coated bars were simply clamped together and heated. This minimal level of adhesive bonding is presumably due to the fact that the two polyamine-treated surfaces display a relatively high local surface energy, as described in Example 11.

To further confirm the existence of a covalent network between the epoxy matrix and the polyamine that is covalently bound to the UHMWPE surface (by ruling out the possibility that a simple increase to the substrate polymer's surface energy is responsible for improved adhesion) one additional experiment was carried out in which the hardener reagent was left out of the adhesant layer. Specifically, a layer of epoxy (with no hardener) was sandwiched between two UHMWPE bars that had each been pre-treated with 1.0 mg of 3a-B2, and the resulting lap-shear sample was thermally cured for the same amount of time that had been used for the epoxy/hardener samples described above. Testing revealed an adhesion strength of 1.11±0.06 MPa—less than the 2.5 MPa observed for the test samples in FIG. 31, but much more than the 0.2 MPa measured in the primer controls. Because epoxy resin itself (i.e. in the absence of hardener) is a poor adhesive, this result unambiguously confirms the existence of covalent bonds between the epoxy and the amine-treated surface.

What is claimed is:

1. A method for the preparation of a polymer composite material comprising the steps of:
a) Treating a polymer substrate with a diazirine-polyamine primer; and
b) Treating the product of step (a) with an epoxy resin and curing the resulting mixture.

2. The method of claim 1 wherein the curing step is carried out in the presence of a hardener.

3. The method of claim 2 wherein the product of step (a) is sized with an epoxy resin prior to step (b).

4. The method of claim 2 wherein the polymer is a low-functionality polymer.

5. The method of claim 4 wherein the polymer is selected from the group consisting of polyethylene and polypropylene.

6. The method of claim 5 wherein the polymer is ultra-high molecular weight polyethylene.

7. The method of claim 1 wherein the primer is derived from a polyamine which is an oligomeric or polymeric compound containing at least 3 repeat units, where each repeat unit is a molecular fragment defined by 1 or more nitrogen atoms covalently bonded to 1 or more carbon atoms.

8. The method of claim 7 wherein the primer is derived from the group consisting of diazirine-containing benzyl halides, diazirine-containing aliphatic alkyl halides, diazirine-containing epoxides, diazirine-containing anhydrides, diazirine-containing NHS esters, diazirine-containing carboxylic acids, diazirine-containing aldehydes, and diazirine-containing haloaromatics.

9. A polymer composite material prepared by a method comprising the steps of:
a) Treating a polymer substrate with a diazirine-polyamine primer; and
b) Treating the product of step (a) with an epoxy resin and curing the resulting mixture.

10. A polymer composite material prepared by a method comprising the steps of:
a) Treating a polymer substrate with a diazirine-polyamine primer;
b) Treating the product of step (a) with epoxy resin; and
c) Treating the product of step (b) with an epoxy resin and curing the resulting mixture.

11. The use of a diazirine-containing polymer for the adhesion of a substrate comprising a non-biological material.

12. The use of claim 11 wherein the substrate is a polymeric material.

13. The use of claim 12 wherein the substrate is a low surface energy material.

14. The use of claim 12 wherein the substrate is selected from the group consisting of polyethylene, polypropylene, polyethylene terephthalate, silicone, and a fluoropolymer.

15. The use of claims 11-14, where the diazirine-containing polymer incorporates the diazirine groups into the backbone of the polymer or copolymer chain.

16. The use of claims 11-14, where the diazirine-containing polymer incorporates the diazirine groups into sidechains that are attached to the polymer or copolymer chain.

17. The use of claims 11-14, where the diazirine-containing polymer is a graft polymer.

18. The use of claim 17, where the graft polymer is a diazirine conjugate of a polyamine.

19. The use of claim 18, where the graft polymer is a diazirine conjugate of linear or branched polyethylenimine.

20. The use of claims 11-19 where the diazirine-containing polymer is applied as a single-agent adhesive.

21. The use of claims 11-19 where the diazirine-containing polymer is applied as a primer that facilitates the bonding of a secondary adhesive.

22. The use of claims 11-21 where a thermal activation is used to activate the diazirine groups.

23. The use of claims 11-21 where a photochemical activation is used to activate the diazirine groups.

24. The use of claims 11-21 where an electrical potential is used to activate the diazirine groups.

25. The use of claims 11-21 where a photosensitizer plays a role in activating the diazirine groups.
